(19) United States
(12) Patent Application Publication
(10) Pub. No.: US 2009/0129819 A1
(43) Pub. Date: May 21, 2009

(54) Exposure Head and Image Forming Device

(75) Inventors: Nozomu INOUE, Matsumoto-shi (JP); Yujiro NOMURA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/274,175

(22) Filed: Nov. 19, 2008

(30) Foreign Application Priority Data
Nov. 19, 2007 (JP) 2007-299187
Sep. 22, 2008 (JP) 2008-243005

(51) Int. Cl. G03G 15/02

(52) U.S. Cl. 399/220

(57) ABSTRACT

An exposure head includes an imaging optical system arranged in a first direction, and first and second light emitting elements disposed in a second direction substantially perpendicular to the first direction that emit light beams to be imaged by the imaging optical system to form light-collected sections adjacent to each other in the first direction. A first wiring is electrically connected to and extended out from the first light emitting element to one side in the second direction. A second wiring is electrically connected to and extended out from the second light emitting element to the one side in the second direction.

### CROSS-REFERENCE TO RELATED APPLICATIONS

This application claims the benefit of priority under 35 USC 119 of Japanese application no. 2007-299187, filed on Nov. 19, 2007, and Japanese application no. 2008-243005, filed on Sep. 22, 2008, which are incorporated herein by reference.

### BACKGROUND

1. Technical Field

The present invention relates to an exposure head adapted to image a light beam emitted from a light emitting element with a lens and an image forming device using the exposure head.

2. Related Art

A line head using a light emitting element array composed of a plurality of light emitting elements arranged linearly is proposed as an exposure head in, for example, JP-A-2000-158705. In this line head, a light beam emitted from each of the light emitting elements of the light emitting element array is imaged by a lens as a spot to form a spot latent image on an image plane. Thus, the line head in JP-A-2000-158705 forms a plurality of spot latent images aligned in a main-scanning direction.

In order to form a more preferable spot latent image, the spot latent image is preferably formed with a sufficient amount of light using a larger sized light emitting element. However, where a plurality of light emitting elements are arranged linearly, it is not easy to use larger sized light emitting elements because there is a possibility of interference between adjacent light emitting elements. When the pitches between the light emitting elements are reduced for higher resolution, it is even more difficult to increase the sizes of the light emitting elements.

### SUMMARY

The present invention provides an exposure head and an image forming device that form a latent image with a sufficient amount of light.

An exposure head according to an aspect of the invention includes an imaging optical system arranged in a first direction, and first and second light emitting elements disposed in a second direction substantially perpendicular to the first direction that emit light beams to be imaged by the imaging optical system to form light-collected sections adjacent to each other in the first direction. A first wiring is electrically connected to and extended out from the first light emitting element to one side in the second direction, and a second wiring is electrically connected to and extended out from the second light emitting element to the one side in the second direction.

An image forming device according to another aspect of the invention includes a latent image carrier, an exposure head having an imaging optical system arranged in a first direction, and first and second light emitting elements disposed at positions different from each other in a second direction substantially perpendicular to the first direction that emit light beams to be imaged on the latent image carrier by the imaging optical system to form latent images adjacent to each other in the first direction on the latent image carrier. A first wiring is electrically connected to and extended out from the first light emitting element to one side in the second direction, and a second wiring is electrically connected to and extended out from the second light emitting element to the one side in the second direction. A development section develops the latent images formed by the exposure head on the latent image carrier.

In this aspect of the invention, the first and second light emitting elements are disposed at different positions in the second direction. Therefore, the sizes of the first and second light emitting elements can be increased. Thus the light-collected sections can be formed with a sufficient amount of light, thereby facilitating preferable latent image formation.

Further, in this aspect of the invention, the wirings connected to the light emitting elements are extended out to the one side in the second direction. Therefore, the wirings can be extended in a lump and the extension of the wirings is easy.

Further, in this aspect of the invention in which the wirings are extended out on one side in the second direction, a circuit electrically connected to the first and second wirings can be disposed on the one side in the second direction. By adopting this configuration, it is possible to connect the wirings from the light emitting elements to the circuit in a lump, thus it is easy to extend the wirings.

Further, the circuit may be a drive circuit for driving the first and second light emitting elements. Since a drive circuit can be disposed near to the light emitting elements, the wirings can be made relatively short. This configuration is advantageous to preferable latent image formation operation since a signal hardly blunted by the stray capacitance of the wirings is supplied to the light emitting elements. Such a drive circuit can be formed of a thin film transistor (TFT).

The circuit is not limited to a drive circuit. A flexible printed circuit (FPC), for example, can also be adopted. By disposing an FPC electrically connected to the wirings on the one side in the second direction, the wirings from the light emitting elements can be connected to the FPC in a lump, and thus it is easy to extend the wirings.

Further, the first and second light emitting elements can be arranged to emit light in accordance with movement of the latent image carrier to form the latent images adjacent to each other in the first direction. By thus disposing the first and second light emitting elements, the sizes of the first and second light emitting elements can be increased, thus the light-collected sections can be formed with a sufficient amount of light, thereby making it possible to preferably perform the latent image formation.

Further, the width of the first light emitting element in the first direction may be longer than the distance between the first and second light emitting elements in the first direction. By using a light emitting element having such a size, the light-collected section can be formed with a large amount of light, and preferable formation of the latent images is possible.

Further, a pitch in the second direction between a first latent image formed by the first light emitting element and a second latent image formed by the second light emitting element when the first and second light emitting elements emit light simultaneously may be an integral multiple of a pitch in the second direction between pixels. By making the light emitting elements emit light at the same timing, the light-collected sections can appropriately be formed on the respective pixels. Therefore, the emission timing control of the light emitting elements is simplified.

Further, organic EL elements, which only emit light with low intensity, are preferably used as the light emitting elements. From the viewpoint of forming the light-collected sections with a sufficient amount of light, it is preferable to apply this aspect of the invention by increasing the size of the light emitting element to such a configuration. In particular, since the bottom emission organic EL elements emit light with lower intensity, this aspect of the invention is preferably applied to configurations using the bottom emission organic EL elements as the light emitting elements.

Further, the latent images may be developed using liquid developer. Relatively high resolution development can be performed with the liquid developer, and thus it is suitable for preferable image formation.

An exposure head according to another aspect of the invention includes a plurality of light emitting elements grouped into a plurality of light emitting element groups, a substrate having a plurality of wirings connected respectively to the light emitting elements, and a lens array having a plurality of lenses corresponding to the light emitting element groups. The lenses image light beams emitted by the light emitting elements of the light emitting element group as spots to form spot latent images on an image plane moving in a second direction substantially perpendicular to the first direction. The light emitting elements are disposed in the light emitting element group at positions different from each other in a direction corresponding to the first direction. The light emitting element groups emit light beams to form spot latent images in different exposure areas in the first direction. Two light emitting element groups forming spot latent images in exposure areas adjacent to each other in the first direction are disposed on the substrate and shifted from each other in a direction corresponding to the second direction. Wirings connected to light emitting elements belonging to the same light emitting element group are extended out to the same side of the light emitting element group in a direction corresponding to the second direction.

An image forming device according to another aspect of the invention includes a latent image carrier having a surface moving in a second direction substantially perpendicular to a first direction, an exposure head having a substrate having a plurality of light emitting elements divided into groups to form light emitting element groups, and wirings connected to the light emitting elements, and a lens array having a plurality of lenses that image the light beams emitted from the light emitting elements of the light emitting element groups as spots to form spot latent images on a surface of the latent image carrier. The lenses are provided in correspondence to the light emitting element groups. The light emitting elements are disposed in the light emitting element group at different positions in a direction corresponding to the first direction. The light emitting element groups emit light beams to form spot latent images indifferent exposure areas in the first direction. Two light emitting element groups forming spot latent images in the exposure areas adjacent to each other in the first direction are disposed on the substrate and shifted from each other in a direction corresponding to the second direction. Wirings connected to light emitting elements belonging to the same light emitting element group are extended out to the same side of the light emitting element group in a direction corresponding to the second direction.

In this aspect of the invention, the plurality of light emitting elements are grouped into a plurality of light emitting element groups. Moreover, the two light emitting element groups forming spot latent images in the exposure areas adjacent to each other in the first direction are shifted from each other in a direction corresponding to the second direction. As a result, since the light emitting element groups are disposed discretely in the first direction, the light emitting element groups can be disposed in relatively large spaces. Therefore, the size of the light emitting elements forming the light emitting element group can be increased with relative ease, thus making it possible to form the spot latent image with a sufficient amount of light.

Where a plurality of light emitting elements are grouped into a plurality of light emitting element groups, it is desirable to extend the wirings connected to the same light emitting element group in a lump for every light emitting element group in order to simplify the wiring pattern. In this regard, wirings connected respectively to light emitting elements belonging to the same light emitting element group are extended out to the same side of the light emitting element group in a direction corresponding to the second direction. Therefore, the wiring corresponding to the same light emitting element group can be extended on the substrate in a lump, and the wiring pattern is simplified.

It is also possible to connect wirings to the light emitting elements from the side to which the wirings are extended out with respect to the light emitting elements belonging to the same light emitting element group. In such a configuration, the wiring distance of the light emitting element is shortened and the wiring is simplified.

It is also possible to arrange the wirings extended from the light emitting element group in a direction corresponding to the first direction in the order in which the connection destination light emitting elements are arranged in the first direction in the light emitting element group. In such a configuration, emission control of the light emitting element is simplified.

A plurality of spot latent images may also be formed to be aligned in the first direction by the light emitting elements of the light emitting element group emitting light at a timing in accordance with the movement of the image plane. In the light emitting element group, a plurality of light emitting element rows each having a plurality of light emitting elements aligned in a direction corresponding to the first direction is arranged side by side in a direction corresponding to the second direction. The light emitting element rows are shifted from each other in a direction corresponding to the first direction so that the two light emitting elements forming the spot latent images adjacent to each other in the first direction belong respectively to different light emitting element rows. In this configuration, the two light emitting elements forming spot latent images adjacent to each other in the first direction are shifted from each other in a direction corresponding to the second direction. Therefore, since the light emitting element can be formed in a relatively large space, the size of the light emitting element can be increased. Therefore, the spot latent image is formed with a sufficient amount of light, thus preferable spot latent image formation is possible.

Further, if the pitch in a direction corresponding to the first direction of the two light emitting elements forming the spot latent images adjacent to each other in the first direction is a light emitting element pitch, the diameter of the light emitting element in a direction corresponding to the first direction may be longer than the light emitting element pitch. By using light emitting element having such a size, the spot latent images can be formed with a large amount of light, thus facilitating preferable formation of the spot latent images.

Further, if the plurality of spots formed side by side in the first direction by the emission of the light emitting element row is defined as a spot row, the light emitting element rows may be disposed so that the pitch in the second direction of the plurality of spot rows formed on the image plane in response to the simultaneous emission of the light emitting element groups is an integer multiple of the pixel pitch in the second direction. By making the light emitting element rows emit light at the same timing, the spot latent images can appropriately be formed on the respective pixels. Therefore, emission timing control of the light emitting elements is simplified.

Further, in the image forming device described above, the spot latent images can be developed using the liquid developer. By using liquid developer, development of the latent images can be performed with high resolution. Therefore, development of the spot latent images is preferably performed using liquid developers.

### BRIEF DESCRIPTION OF THE DRAWINGS

The invention will be described with reference to the accompanying drawings, wherein like numbers reference like elements.

FIG. 1 is a diagram for explaining terms used in the specification.

FIG. 2 is a diagram for explaining terms used in the specification.

FIG. 3 is a diagram of an image forming device according to an embodiment of the invention.

FIG. 4 is a block diagram showing an electrical configuration of the image forming device of FIG. 3.

FIG. 5 is a perspective view of a line head according to the embodiment of the invention.

FIG. 6 is a cross-sectional view of the line head of FIG. 5 taken along the width direction.

FIG. 7 is a perspective view of a lens array.

FIG. 8 is a cross-sectional view of the lens array taken along the longitudinal direction LGD.

FIG. 9 is a diagram showing a configuration of the reverse side of a head substrate.

FIG. 10 is a plan view showing a configuration of a light emitting element group.

FIG. 11 is a block diagram showing a configuration of a main controller.

FIG. 12 is a block diagram showing a configuration of a head controller.

FIG. 13 is a block diagram showing a configuration of a head control block of the present embodiment.

FIG. 14 is a perspective view for explaining a spot forming operation.

FIG. 15 is a diagram showing spot groups formed on the surface of the photoconductor drum according to the present embodiment.

FIG. 16 is a diagram for explaining in-group sub-scanning positions.

FIG. 17 is a diagram showing an example of a spot latent image forming operation.

FIG. 18 is a plan view showing another configuration of a light emitting element group.

FIG. 19 is a plan view showing still another configuration of a light emitting element group.

FIG. 20 is a plan view showing a modified example of a light emitting element group and wiring thereof.

FIG. 21 is a plan view showing a modified example of a light emitting element group and wiring thereof.

FIG. 22 is a plan view showing a modified example of a light emitting element group and wiring thereof.

FIG. 23 is a plan view showing a modified example of a light emitting element group and wiring thereof.

FIG. 24 is a diagram of a device for performing development with a liquid developer.

### DESCRIPTION OF EXEMPLARY EMBODIMENTS

### A. Explanations of Terms

Before explaining embodiments of the invention, the terms used in this specification will be explained.

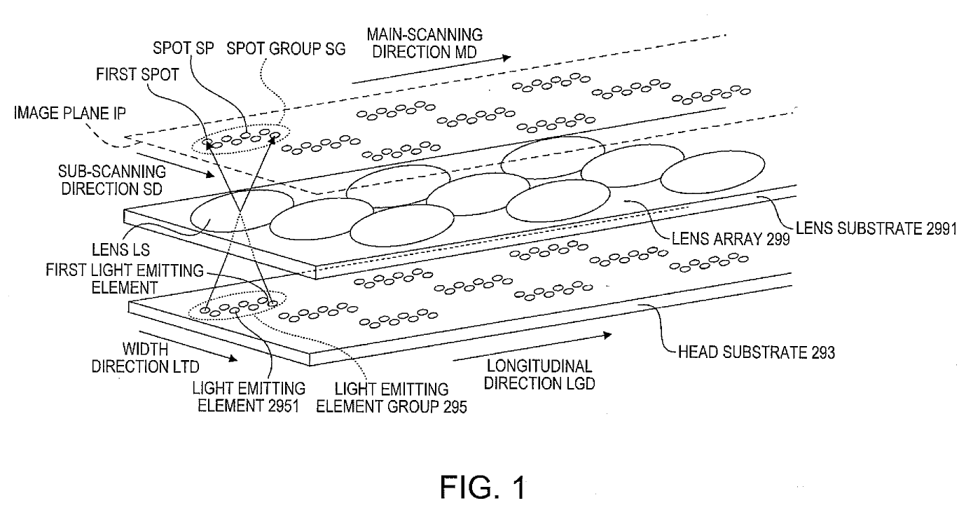

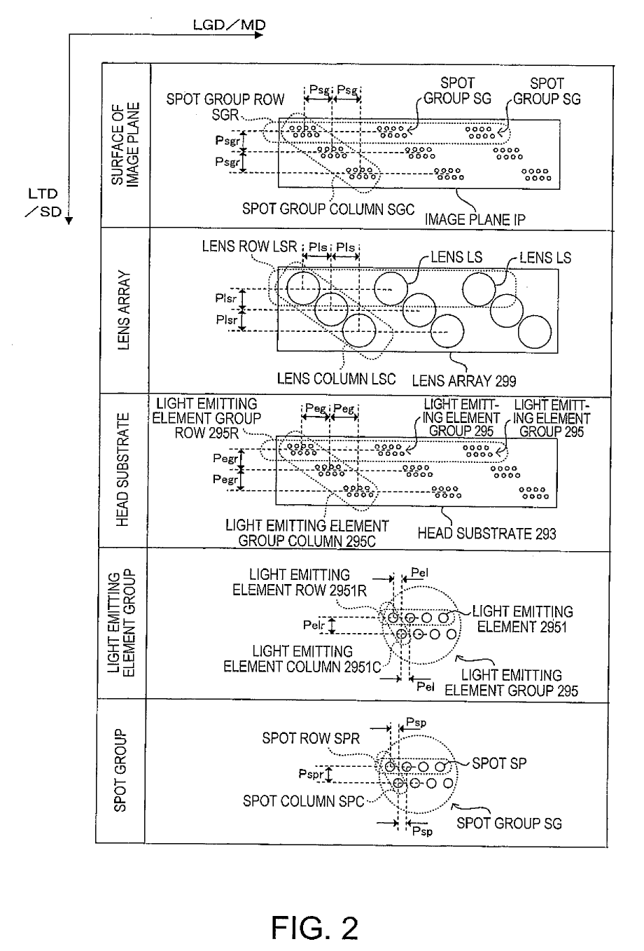

FIGS. 1 and 2 are diagrams for explaining and organizing the terms used in this specification. A conveying direction on a surface (image plane IP) of a photoconductor drum 21 is defined as a sub-scanning direction SD, and a direction perpendicular to or substantially perpendicular to the sub-scanning direction SD is defined as a main-scanning direction MD. A line head 29 is disposed facing to the surface (the image plane IP) of the photoconductor drum 21 so that a longitudinal direction LGD thereof corresponds to the main-scanning direction MD, and a width direction LTD corresponds to the sub-scanning direction SD.

An aggregate of a plurality (eight in FIGS. 1 and 2) of light emitting elements 2951, which is disposed on a head substrate 293 in one-to-one correspondence with each of lenses LS included in a lens array 299, is defined as a light emitting element group 295. In other words, the light emitting element group 295 formed of a plurality of light emitting elements 2951 is disposed on the head substrate 293 corresponding to each of the plurality of lenses LS. An aggregate of a plurality of spots SP formed on the image plane IP by imaging the light beams from the light emitting element group 295 on the image plane IP by the lens LS corresponding to the light emitting element group 295 is defined as a spot group SG. In other words, a plurality of spot groups SG can be formed in one-to-one correspondence with a plurality of light emitting groups 295. The spot located uppermost stream in both the main-scanning direction MD and the sub-scanning direction SD in each of the spot groups SG is defined as the first spot, and the light emitting element 2951 corresponding to the first spot is defined as the first light emitting element.

Spot group row SGR and spot group column SGC are defined as shown in the “SURFACE OF IMAGE PLANE” column in FIG. 2. In other words, a plurality of spot groups SG arranged in the main-scanning direction MD is defined as a spot group row SGR. A plurality of spot group rows SGR is arranged side by side in the sub-scanning direction SD at a predetermined spot group row pitch Psgr. A plurality (three in the drawing) of spot groups SG arranged consecutively at a pitch having a component of the sub-scanning direction SD equal to the spot group row pitch Psgr and a component of the main-scanning direction MD equal to a spot group pitch Psg is defined as a spot group column SGC. The spot group row pitch Psgr is a distance in the sub-scanning direction SD between the geometric centroids of the respective two spot group rows GSR adjacent to each other in the sub-scanning direction SD. The spot group pitch Psg is a distance in the main-scanning direction MD between the geometric centroids of the respective two spot groups SG adjacent to each other in the main-scanning direction MD.

Lens row LSR and lens column LSC are defined as shown in the “LENS ARRAY” column in the drawing. A plurality of lenses LS arranged in the longitudinal direction LGD is defined as the lens row LSR. A plurality of lens rows LSR is arranged side by side in the width direction LTD at a predetermined lens row pitch Plsr. A plurality (three in the drawing) of lenses LS arranged consecutively at a pitch having a component of the width direction LTD equal to the lens row pitch Plsr and a component of the longitudinal direction LGD equal to a lens pitch Pls is defined as a lens column LSC. The lens row pitch Plsr is a distance in the width direction LTD between the geometric centroids of the respective two lens rows LSR adjacent to each other in the width direction LTD. The lens pitch Pls is a distance in the longitudinal direction LGD between the geometric centroids of the respective two lens LS adjacent to each other in the longitudinal direction LGD.

Light emitting element group row 295R and light emitting element group column 295C are defined as shown in the “HEAD SUBSTRATE” column in the drawing. A plurality of light emitting element groups 295 arranged in the longitudinal direction LGD is defined as the light emitting element group row 295R. A plurality of light emitting group rows 295R is arranged side by side in the width direction LTD at a predetermined light emitting element group row pitch Pegr. A plurality (three in the drawing) of light emitting element groups 295 arranged consecutively at a pitch having a component of the width direction LTD equal to the light emitting element group row pitch Pegr and a component of the longitudinal direction LGD equal to a light emitting element group pitch Peg is defined as a light emitting element group column 295C The light emitting element group row pitch Pegr is a distance in the width direction LTD between the geometric centroids of the respective two light emitting element group rows 295R adjacent to each other in the width direction LTD. The light emitting element group pitch Peg is a distance in the longitudinal direction LGD between the geometric centroids of the respective two light emitting element groups 295 adjacent to each other in the longitudinal direction LGD.

Light emitting element row 2951R and light emitting element column 2951C are defined as shown in the “LIGHT EMITTING ELEMENT GROUP” column in the drawing. In each of the light emitting element groups 295, a plurality of light emitting elements 2951 arranged in the longitudinal direction LGD is defined as the light emitting element group row 2951R. A plurality of light emitting element rows 2951R is arranged side by side in the width direction LTD at a predetermined light emitting element row pitch Pelr. A plurality (two in the drawing) of light emitting elements 2951 arranged consecutively at a pitch having a component of the width direction LTD equal to the light emitting element row pitch Pelr and a component of the longitudinal direction LGD equal to a light emitting element pitch Pel is defined as a light emitting element column 2951C. The light emitting element row pitch Pelr is a distance in the width direction LTD between the geometric centroids of the respective two light emitting element rows 2951R adjacent to each other in the width direction LTD. The light emitting element pitch Pel is a distance in the longitudinal direction LGD between the geometric centroids of the respective two light emitting elements 2951 adjacent to each other in the longitudinal direction LGD.

Spot row SPR and spot column SPC are defined as shown in the “SPOT GROUP” column in the drawing. In each of the spot groups SG, a plurality of spots SP arranged in the longitudinal direction LGD is defined as the spot row SPR. A plurality of spot rows SPR is arranged side by side in the width direction LTD at a predetermined spot row pitch Pspr. A plurality (two in the drawing) of spots SP arranged consecutively at a pitch having a component of the width direction LTD equal to the spot row pitch Pspr and a component of the longitudinal direction LGD equal to a spot pitch Psp is defined as a spot column SPC. The spot row pitch Pspr is a distance in the sub-scanning direction SD between the geometric centroids of the respective two spot rows SPR adjacent to each other in the sub-scanning direction SD. The spot pitch Psp is a distance in the main-scanning direction MD between the geometric centroids of the respective two spots SP adjacent to each other in the longitudinal direction LGD.

### B. Embodiments

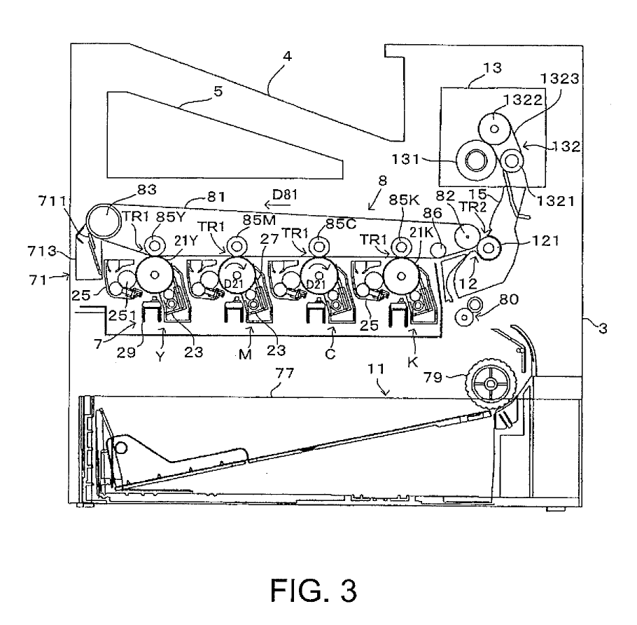

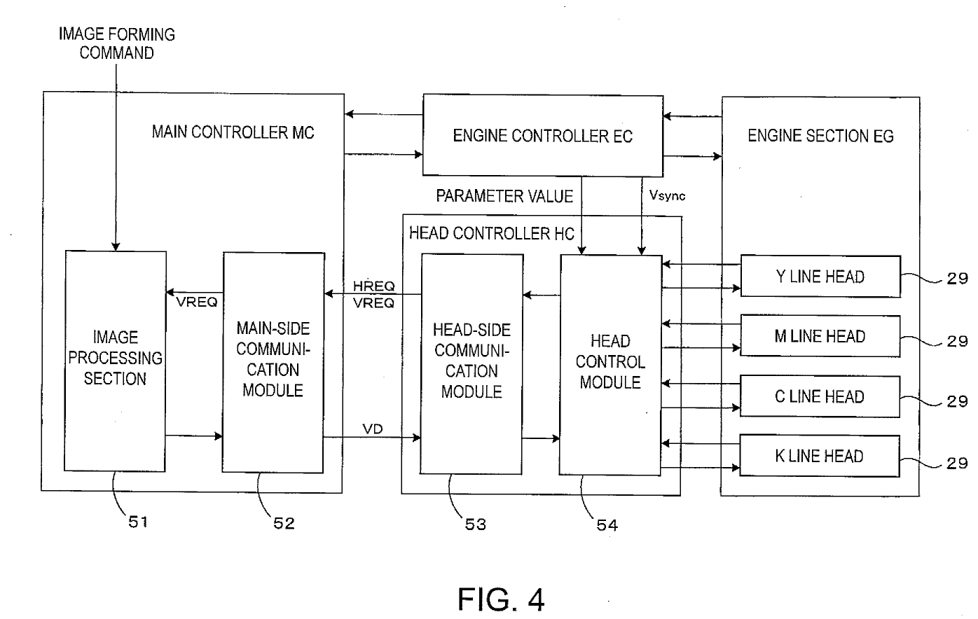

FIG. 3 is a diagram of an image forming device according to an embodiment of the invention. FIG. 4is a diagram showing an electrical configuration of the image forming device of FIG. 3. The image forming device can selectively perform a color mode in which a color image is formed by overlapping four colors of toners of black (K), cyan (C), magenta (M), and yellow (Y), and a monochrome mode in which a monochrome image is formed using only the black (K) toner. FIG. 3 corresponds to a state when performing the color mode. In the image forming device, when an image formation command is provided to a main controller MC having a CPU, a memory, and so on from an external device such as a host computer, the main controller MC provides an engine controller EC with a control signal, and a head controller HC with the video data VD corresponding to the image formation command. The head controller HC controls line heads 29 in charge of respective colors based on the video data VD from the main controller MC and a vertical sync signal Vsync and parameter values from the engine controller EC. Thus, an engine section EG performs a prescribed image forming operation, thereby forming an image corresponding to the image formation command on a sheet such as copy paper, transfer paper, a form, or an OHP transparent sheet.

An electric component box 5 housing a power supply circuit board, the main controller MC, and the engine controller EC is disposed inside a main housing 3 of the image forming device. An image forming unit 7, a transfer belt unit 8, and a paper feed unit 11 are also disposed inside the main housing 3. A secondary transfer unit 12, a fixing unit 13, and a sheet guide member 15 are disposed inside and on the right side of the main housing 3 in FIG. 3. The paper feed unit 11 is detachably mounted to a main body 1 of the device. The paper feed unit 11 and the transfer belt unit 8 can separately be detached from the main body to be repaired or replaced.

The image forming unit 7 is provided with four image forming stations Y (yellow), M (magenta), C (cyan), and K (black) for forming images with respective colors different from each other. Each of the image forming stations Y, M, C, and K is provided with a cylindrical photoconductor drum 21 having a surface with a predetermined length in the main-scanning direction MD. Each of the image forming stations Y, M, C, and K forms a toner image of the corresponding color on the surface of the photoconductor drum 21. The axial direction of the photoconductor drum is substantially parallel to the main-scanning direction MD. Each of the photoconductor drums 21 is connected to a dedicated drive motor, and is driven to rotate at a predetermined speed in a direction of the arrow D21 in the drawing. Thus, the surface of the photoconductor drum 21 is moved in the sub-scanning direction SD perpendicular to or substantially perpendicular to the main-scanning direction MD. A charging section 23, the line head 29, a developing section 25, and a photoconductor cleaner 27 are disposed around the photoconductor drum 21 along the rotational direction. Charging, latent image forming, and toner developing operations are executed by these functional sections. Therefore, when executing the color mode, the toner images respectively formed by all of the image forming stations Y, M, C, and K are overlapped on a transfer belt 81 provided to a transfer belt unit 8 to form a color image, and when executing the monochrome mode, a monochrome image is formed using only the toner image formed by the image forming station K. In FIG. 3, since the image forming stations in the image forming unit 7 have the same configurations as each other, the reference numerals are only provided to some of the image forming stations, and are omitted in the rest of the image forming stations only for simplicity of illustration.

The charging section 23 includes a charging roller having a surface made of elastic rubber. The charging roller is rotated by contact with the surface of the photoconductor drum 21 at a charging position, and is rotated in association with the rotational operation of the photoconductor drum 21 in a driven direction with respect to the photoconductor drum 21 at a circumferential speed. The charging roller is connected to a charging bias generating section, accepts the power supply for the charging bias from the charging bias generating section, and charges the surface of the photoconductor drum 21 at the charging position where the charging section 23 and the photoconductor drum 21 have contact with each other.

The line head 29 is disposed corresponding to the photoconductor drum 21 so that the longitudinal direction thereof corresponds to the main-scanning direction MD and the width direction thereof corresponds to the sub-scanning direction SD, and the longitudinal direction of the line head 29 is substantially parallel to the main-scanning direction MD. The line head 29 includes a plurality of light emitting elements arranged in the longitudinal direction, and is disposed separately from the photoconductor drum 21. The light emitting elements emit light onto the surface of the photoconductor drum 21 charged by the charging section 23, thereby forming an electrostatic latent image on the surface thereof.

The developing section 25 has a developing roller 251 with a surface holding the toner. The charged toner is moved to the photoconductor drum 21 from the developing roller 251 by a developing bias applied to the developing roller 251 from a developing bias generating section electrically connected to the developing roller 251 at the developing position where the developing roller 251 and the photoconductor drum 21 contact each other, thereby making the electrostatic latent image formed by the line head 29 visible.

The toner image thus made visible at the developing position is fed in the rotational direction D21 of the photoconductor drum 21, and then primary-transferred to the transfer belt 81 at a primary transfer position TR1 where the transfer belt 81 and the photoconductor drums 21 contact each other.

The photoconductor cleaner 27 is disposed downstream of the primary transfer position TR1 and upstream of the charging section 23 in the rotational direction D21 of the photoconductor drum 21 so as to contact the surface of the photoconductor drum 21. The photoconductor cleaner 27 removes residual toner on the surface of the photoconductor drum 21 after the primary transfer to clean the surface thereof by contacting the surface of the photoconductor drum 21.

The transfer belt unit 8 includes a drive roller 82, a driven roller 83 (also referred to as a blade-opposed roller 83) disposed on the left of the drive roller 82 in FIG. 3, and the transfer belt 81 stretched across these rollers and circularly driven in the direction (feeding direction) of the arrow D81 shown in the drawing. The transfer belt unit 8 includes four primary transfer rollers 85Y, 85M, 85C, and 85K disposed inside the transfer belt 81 respectively opposed one-on-one to the photoconductor drums 21 included in the image forming stations Y, M, C, and K when the photoconductor cartridges are mounted. The primary transfer rollers 85 are electrically connected to respective primary transfer bias generating sections. As described later in detail, when executing the color mode, all of the primary transfer rollers 85Y, 85M, 85C, and 85K are positioned on the side of the image forming stations Y, M, C, and K as shown in FIG. 3 to press the transfer belt 81 against the photoconductor drums 21 included in the respective image forming stations Y, M, C, and K, thereby forming the primary transfer position TR1 between each of the photoconductor drums 21 and the transfer belt 81. Then, by applying the primary transfer bias to the primary transfer rollers 85 from the primary transfer bias generating section with appropriate timing, the toner images formed on the surfaces of the photoconductor drums 21 are transferred to the surface of the transfer belt 81 at the respective primary transfer positions TR1 to form a color image.

On the other hand, when executing the monochrome mode, the primary transfer rollers 85Y, 85M, and 85C for color printing are separated from the image forming stations respectively opposed thereto, while only the primary transfer roller 85K for monochrome printing is pressed against the image forming station K. Thus, only the image forming station K contacts the transfer belt 81. As a result, the primary transfer position TR1 is formed only between the primary transfer roller 85K and the corresponding image forming station K. Then, by applying the primary transfer bias to the primary transfer roller 85K from the primary transfer bias generating section with appropriate timing, the toner image formed on the surface of the photoconductor drum 21 is transferred to the surface of the transfer belt 81 at the primary transfer position TR1 to form a monochrome image.

The transfer belt unit 8 is provided with a downstream guide roller 86 disposed on the downstream side of the primary transfer roller 85K and on the upstream side of the drive roller 82. The downstream guide roller 86 contacts the transfer belt 81 on a common internal tangent of the primary transfer roller 85K and the photoconductor drum 21 at the primary transfer position TR1 formed by the primary transfer roller 85K contacting the photoconductor drum 21 of the image forming station K.

The drive roller 82 circularly drives the transfer belt 81 in the direction of the arrow D81 shown in the drawing, and at the same time functions as a backup roller of a secondary transfer roller 121. A rubber layer with a thickness of about 3 mm and a volume resistivity of no greater than 1000 kΩ·cm is formed on the peripheral surface of the drive roller 82 that, when grounded via a metal shaft, serves as a conducting path for a secondary transfer bias supplied from a secondary transfer bias generating section via the secondary transfer roller 121. By thus providing a rubber layer having an abrasion resistance and a shock absorbing property to the drive roller 82, the impact caused by a sheet entering the contact section (a secondary transfer position TR2) between the drive roller 82 and the secondary transfer roller 121 is hardly transmitted to the transfer belt 81, thus preventing degradation of image quality.

The paper feed unit 11 includes a paper feed section including a paper feed cassette 77 for holding a stack of sheets and a pickup roller 79 for feeding the sheets one-by-one from the paper feed cassette 77. A sheet fed by the pickup roller 79 from the paper feed section is fed to the secondary transfer position TR2 along the sheet guide member 15 after the feed timing thereof is adjusted by a pair of resist rollers 80.

The secondary transfer roller 121 is driven to selectively contact and separate from the transfer belt 81 by a secondary transfer roller drive mechanism. The fixing unit 13 has a rotatable heating roller 131 having a heater such as a halogen heater built-in and a pressing section 132 for biasing the heating roller 131 to be pressed against an object. A sheet with an image, which is secondary-transferred on the surface thereof, is guided by the sheet guide member 15 to a nipping section formed of the heating roller 131 and a pressing belt 1323 of the pressing section 132, and the image is thermally fixed in the nipping section at a predetermined temperature. The pressing section 132 is composed of the pressing belt 1323 stretched across two rollers 1321, 1322. By pressing a tensioned part of the surface of the pressing belt 1323, which is stretched by the two rollers 1321, 1322 against the peripheral surface of the heating roller 131, a large nipping section is formed between the heating roller 131 and the pressing belt 1323. The sheet on which the fixing process is thus executed is fed to a paper catch tray 4 disposed on an upper surface of the main housing 3.

A cleaner section 71 facing the blade-opposed roller 83 has a cleaner blade 711 and a waste toner box 713. The cleaner blade 711 removes foreign matter such as toner remaining on the transfer belt 81 after the secondary transfer process or paper dust by pressing a tip section thereof against the blade-opposed roller 83 via the transfer belt 81. Foreign matter thus removed is collected into the waste toner box 713. The cleaner blade 711 and the waste toner box 713 are configured integrally with the blade-opposed roller 83. Therefore, the cleaner blade 711 and the waste toner box 713 move together with the blade-opposed roller 83.

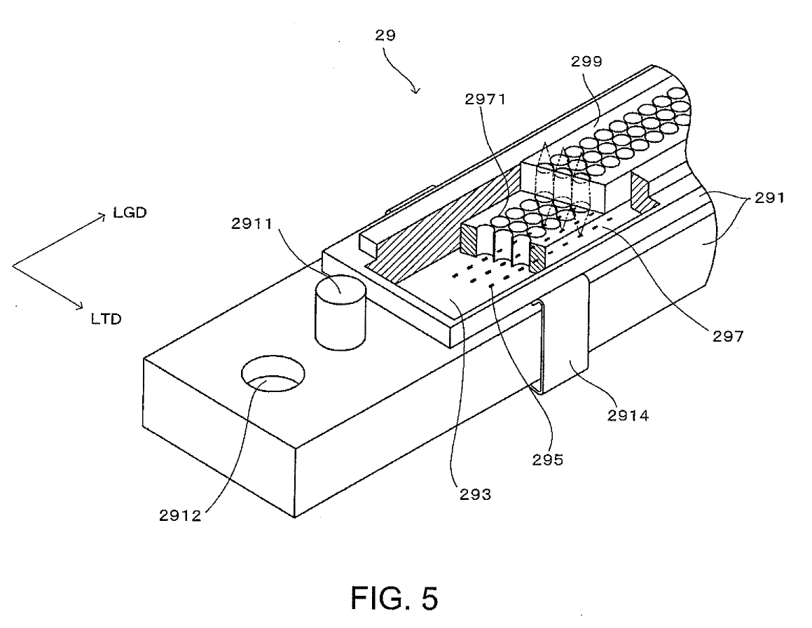

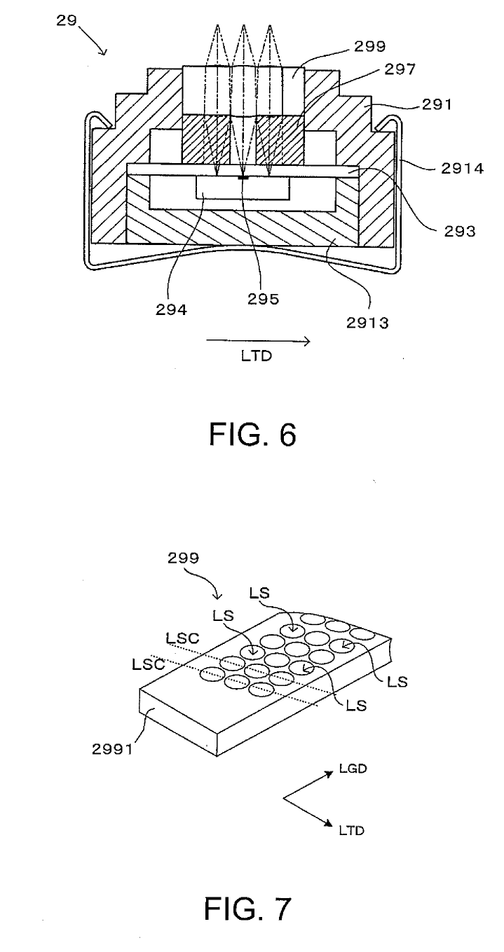

FIG. 5 is a perspective view of a line head according to the embodiment of the invention. FIG. 6 is a cross-sectional view of the line head of FIG. 5 taken along the width direction. As described above, the line head 29 is disposed corresponding to the photoconductor drum 21 so as to have the longitudinal direction LGD thereof correspond to the main-scanning direction MD, and the width direction LTD thereof correspond to the sub-scanning direction SD. The longitudinal direction LGD and the width direction LTD thereof are substantially perpendicular to each other. The line head 29 has a case 291, and each end of the case 291 is provided with a positioning pin 2911 and a screw hole 2912. By fitting the positioning pin 2911 into a positioning hole of a photoconductor cover covering and positioned with respect to the photoconductor drum 21, the line head 29 is positioned with respect to the photoconductor drum 21. Set screws are screwed in and fixed to screw holes of the photoconductor cover via the screw holes 2912, thereby positioning and fixing the line head 29 to the photoconductor drum 21.

The case 291 holds a microlens array 299 at a position opposed to the surface of the photoconductor drum 21. A light shielding member 297 and a head substrate 293 are disposed inside case 291 in this order from the microlens array 299. The head substrate 293 is made of a material (e.g., glass) capable of transmitting a light beam. A plurality of bottom emission organic Electro-Luminescence (EL) elements as the light emitting elements 2951 is disposed on the reverse surface (the opposite surface to the surface with the lens array 299 out of the two surfaces provided to the head substrate 293) of the head substrate 293. The plurality of light emitting elements 2951 is divided into and separately disposed as light emitting element groups 295. The light beams emitted from each of the light emitting element groups 295 penetrate the head substrate 293 from the reverse side to the obverse side thereof and proceed towards the light shielding member 297.

The light shielding member 297 has a plurality of light guide holes 2971 penetrating the light shielding member in one-on-one correspondence to the plurality of light emitting element groups 295. Each light guide hole 2971 is a substantially cylindrical hole penetrating the light shielding member 297 along a line parallel to the normal line of the head substrate 293 as the center axis thereof. Therefore, light beams proceeding towards areas other than the light guide holes 2971 corresponding to the light emitting element group 295 are shielded by the light shielding member 297. Thus, all of the light beams emitted from the same light emitting element group 295 proceed towards the lens array 299 via the same light guide hole 2971, and interference between the light beams emitted from different light emitting element groups 295 is prevented by the light shielding member 297. Light beams passing through the light guide hole 2971 of the light shielding member 297 are each imaged by the lens array 299 on the surface of the photoconductor drum 21 as a spot.

As shown in FIG. 6, a back lid 2913 is pressed by a retainer 2914 against the case 291 via the head substrate 293. The retainer 2914 has elastic force for pressing the back lid 2913 towards the case 291, and seals the inside of the case 291 light-tightly (in other words, so that light does not leak from the inside of the case 291 or enter from the outside of the case 291) by pressing the back lid with such elastic force. The retainer 2914 is disposed in each of a plurality of positions in the longitudinal direction of the case 291. The light emitting element groups 295 are covered by a seal member 294.

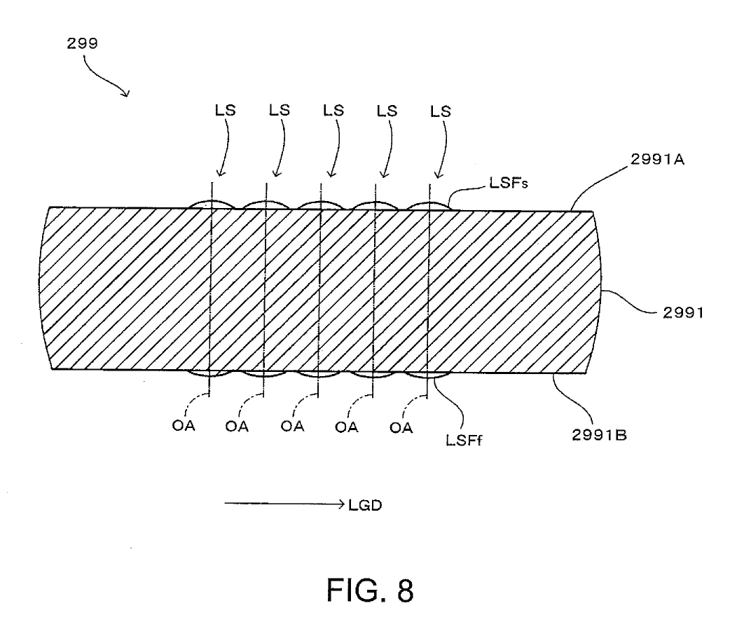

FIG. 7 is a perspective view of the lens array. FIG. 8 is a cross-sectional view of the lens array in the longitudinal direction LGD. The lens array 299 has a lens substrate 2991. A first surface LSFf of the lens LS is formed on the reverse surface 2991B of the lens substrate 2991, and the second surface LSFs of the lens LS is formed on the obverse surface 2991A of the lens substrate 2991. The first surface LSFf and the second surface LSFs of the lens opposed to each other, and the lens substrate 2991 held between the two surfaces, function as one lens LS. The first surface LSFf and the second surface LSFs of the lens LS can be formed from resin, for example.

The lens array 299 has a plurality of lenses LS having respective optical axes OA substantially parallel to each other. The optical axes OA of the lenses LS are substantially perpendicular to the reverse surface (the surface on which the light emitting elements 2951 are disposed) of the head substrate 293. The lenses LS are disposed in one-on-one correspondence to the light emitting element groups 295, and arranged two-dimensionally in correspondence to the arrangement of the light emitting groups 295. A plurality of lens columns LSC composed of three lenses LS disposed at different positions from each other in the width direction LTD is arranged in the longitudinal direction LGD.

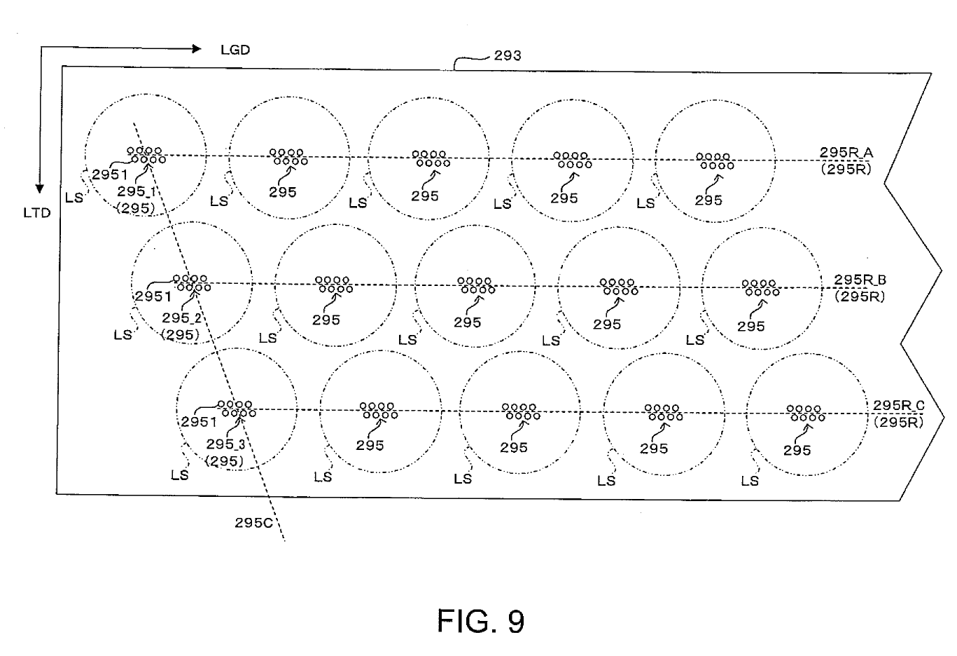

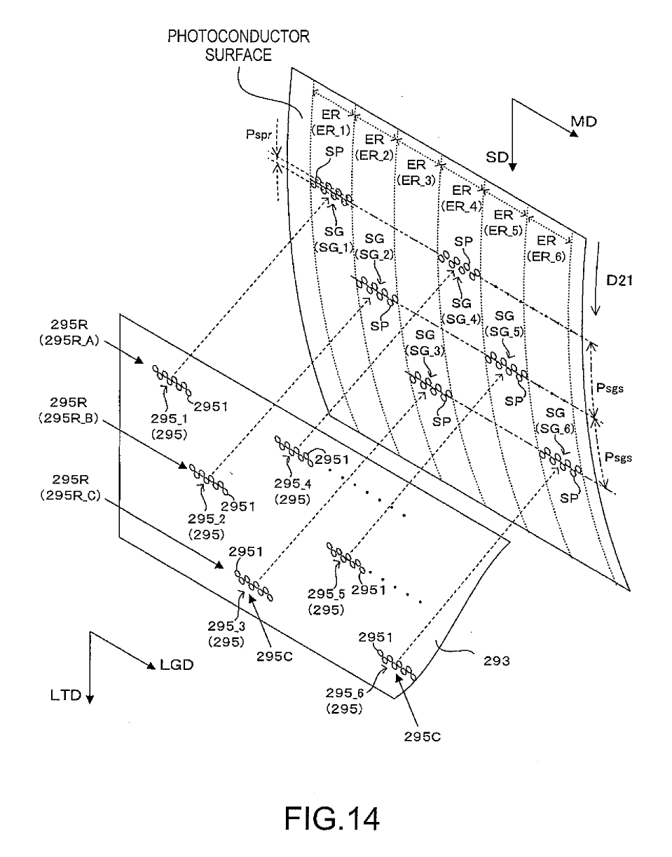

FIG. 9 is a diagram showing a configuration of the reverse surface of the head substrate, corresponding to the case in which the reverse surface is viewed from the obverse surface of the head substrate. In FIG. 9, although the lenses LS are illustrated with double-dashed lines, this does not denote that the lenses LS are disposed on the reverse surface of the substrate, but denotes that the light emitting element groups 295 are disposed in one-on-one correspondence to the lenses LS. As shown in FIG. 9, a plurality of light emitting element group columns 295C, each having three light emitting element groups 295 disposed at positions different from each other in the width direction LTD, are arranged in the longitudinal direction LGD. In other words, the light emitting element group rows 295R having a plurality of light emitting element groups 295 arranged along the longitudinal direction LGD are arranged in the width direction LTD in three rows (295R_A, 295R_B, and 295R_C) In this case, the light emitting element group rows 295R are shifted from each other in the longitudinal direction LGD so that the positions of the light emitting element groups 295 are different from each other in the longitudinal direction LGD. Since the light emitting element groups 295 are arranged as described above, as described later in detail with reference to FIG. 14 and so on, the light emitting element groups 295 form spot latent images in exposure areas different from each other in the main-scanning direction MD. Moreover, the light emitting element groups 295 (e.g., the light emitting element groups 295_1, 295_2, or the light emitting element groups 295_2, 295_3) forming the spot latent images in the exposure areas adjacent to each other in the main-scanning direction MD are shifted from each other in the width direction LTD.

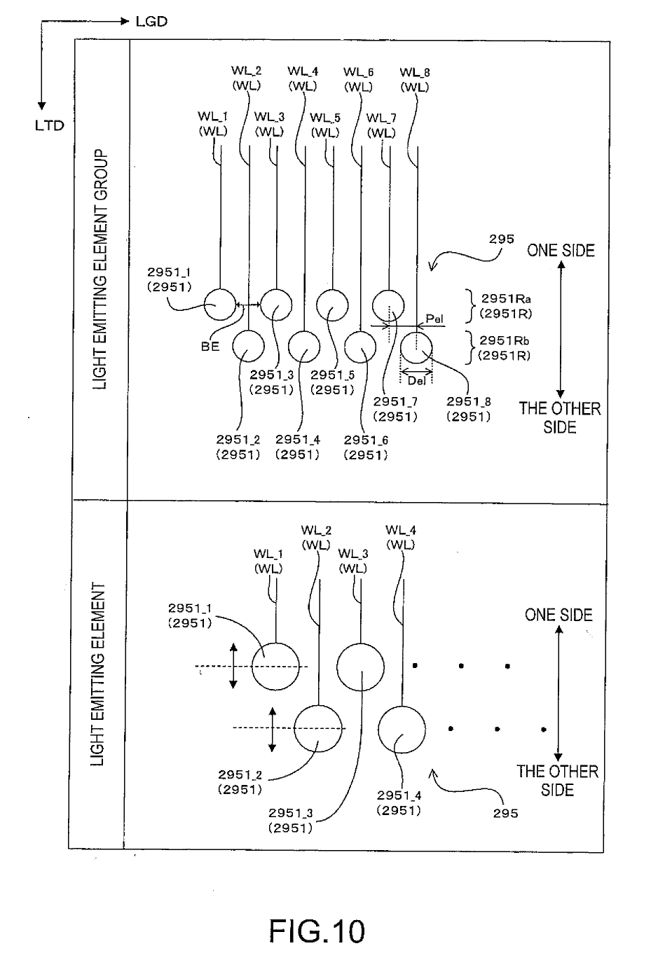

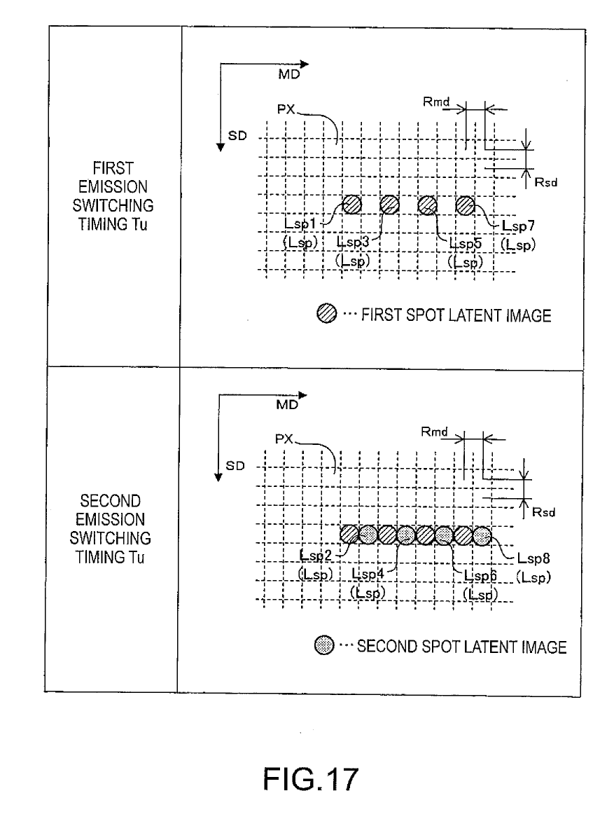

FIG. 10 is a plan view showing a configuration of the light emitting element group. The “LIGHT EMITTING ELEMENT GROUP” column of FIG. 10 shows the light emitting element group 295, and a relationship between the light emitting element group and wiring WL, and the “LIGHT EMITTING ELEMENTS” column shows a relationship between the light emitting elements and the wiring WL. As shown in FIG. 10, two light emitting element rows 2951R each having four light emitting elements 2951 aligned in the longitudinal direction LGD are arranged side by side in the width direction LTD. The light emitting element rows 2951R are shifted by the light emitting element pitch Pel from each other in the longitudinal direction LGD, and the light emitting elements 2951 are located at positions different from each other in the longitudinal direction LGD. Therefore, as explained later with reference to FIG. 17 and so on, each of the light emitting elements 2951_1 through 2951_8 emits light with timing corresponding to the movement of the surface of the photoconductor drum 21, thus the spot latent images Lsp_1 through Lsp_8 are formed so as to be aligned in the main-scanning direction MD. The spot latent images adjacent to each other in the main-scanning direction MD are formed by the light emitting elements 2951 (e.g., the light emitting elements 2951_1, 2951_2 in FIG. 10) belonging to different light emitting element rows 2951R. Here, “the light emitting element pitch Pel” is a pitch in the longitudinal direction LGD between the two light emitting elements 2951 (e.g., light emitting elements 2951_7, 2951_8) forming the spot latent images adjacent to each other in the main-scanning direction MD.

Wirings WL are connected to the light emitting elements 2951 in the light emitting element group 295. For example, a wiring WL_1 is connected to the light emitting element 2951_1 while a wiring WL_2 is connected to the light emitting element 2951_2. All of the wirings WL are extended out to one side (hereinafter referred simply to as “one side”) of the light emitting element group 295 in the width direction LTD. Each of the wirings WL_l-WL_8 is connected to the light emitting element 2951 from the extended-out side of the wirings WL (the one side), and each of the wirings WL_1-WL_8 is extended out directly to the one side of the light emitting element group 295 (see the “LIGHT EMITTING ELEMENT GROUP” column of FIG. 10).

The wirings WL_l-WL_8 extended out from the light emitting element group 295 are arranged in the longitudinal direction LGD in the same order as the order in the longitudinal direction LGD of the light emitting elements 2951 of the light emitting element group 295 to which the wirings WL_l-WL_8 are connected. In other words, as shown in the “LIGHT EMITTING ELEMENT GROUP” column of FIG. 10, the eight light emitting elements 2951 are disposed in the longitudinal direction LGD in the order in which the light emitting elements 2951_1-2951_8 are disposed, and the wirings WL_1-WL_8 are also disposed in the longitudinal direction LGD in the order in which the light emitting elements 2951 as the destination of the wirings WL_1-WL_8 are disposed, namely the wirings WL_1-WL_8 are arranged in the longitudinal direction LGD in this order.

In the present embodiment, the diameter Del of the light emitting element 2951 in the longitudinal direction LGD is longer than the pitch (distance) Pel between the light emitting elements so as to assure a sufficient amount of light of the light emitting element.

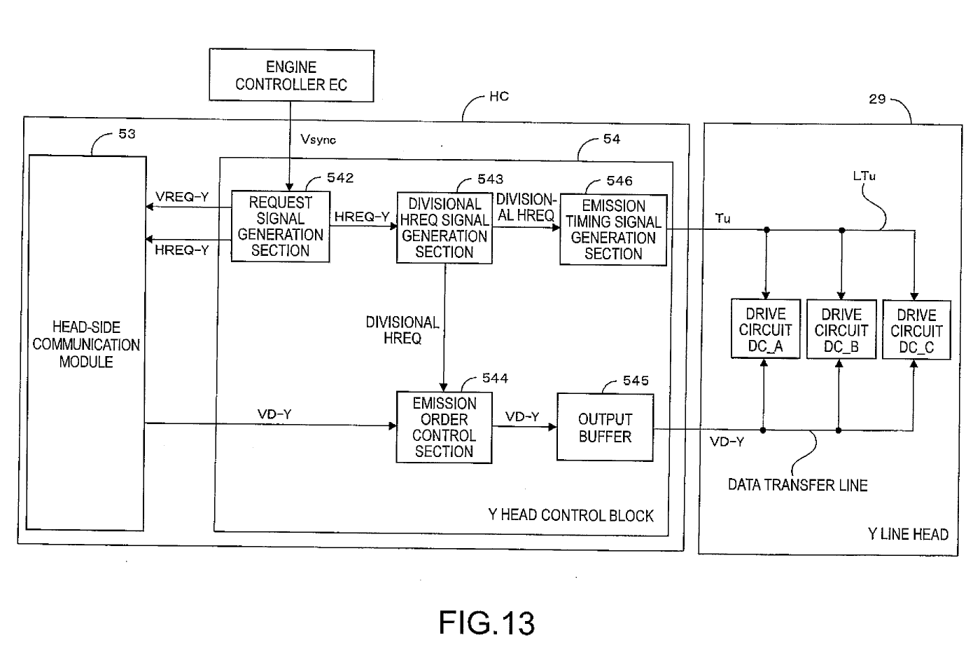

Drive circuits DC_A, DC_B and DC_C are disposed in correspondence, respectively, to light emitting element group rows 295R_A, 295R_B, and 295R_C via the wirings described above, each of which is formed of, for example, thin film transistors (TFTs) (see FIG. 13). When the drive circuits DC_A, DC_B, and DC_C supply the light emitting elements 2951 with a drive signal, the light emitting elements 2951 emit light beams with the same wavelength as each other. The emission surface of the light emitting element 2951 is a so-called perfect diffuse surface light source, and the light beam emitted from the emission surface follows Lambert's cosine law.

The drive operations of the drive circuits DC are controlled based on the video data VD. Specifically, when receiving a vertical request signal VREQ from the head controller HC, the main controller MC generates the video data VD corresponding to one page (FIG. 4). Every time the main controller MC receives a horizontal request signal HREQ from the head controller HC, the video data VD corresponding to one line is transmitted to the head controller HC. The head controller HC controls the drive circuits DC based on the video data thus received. A specific configuration of realizing these control operations is hereinafter explained.

In the present embodiment, there are four sets of the signals described above corresponding respectively to the colors of YMCK, namely, the request signals VREQ, HREQ transmitted from the head controller HC to the main controller MC, and the video data VD transmitted from the main controller MC to the head controller HC. The colors are hereinafter discriminated by adding a hyphen and a symbol representing one of the colors to signal names, if necessary. For example, the vertical request signal, the horizontal request signal, and video data for yellow are denoted as VREQ-Y, HREQ-Y, and VD-Y, respectively.

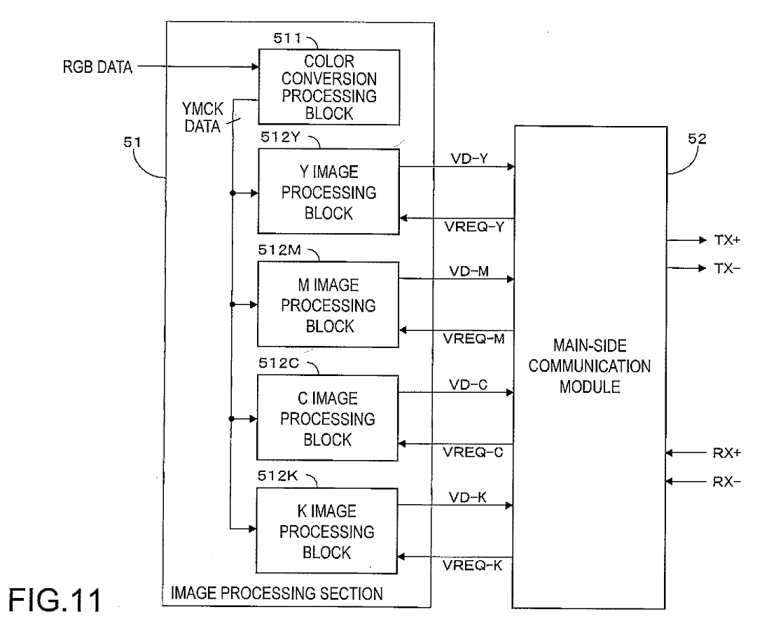

FIG. 11 is a block diagram showing the configuration of the main controller. The main controller MC includes an image processing section 51 for executing necessary signal processing on the image data included in the image formation command provided from an external device, and a main-side communication module 52. The image processing section 51 has a color conversion processing block 511 for developing the RGB image data into YMCK image data corresponding to the respective toner colors. The image processing section 51 includes image processing blocks 512Y (yellow), 512M (magenta), 512C (cyan), and 512K (black) corresponding to the toner colors, and the following signal processing is executed on the image data. Specifically, the image processing blocks 512Y, 512M, 512C, and 512K execute bitmap development on the image data in accordance with the resolution of the line heads 29, and then execute screen treatment, gamma correction, and so on, on the bitmap-developed data to generate the video data VD-Y, VD-M, VD-C, and VD-K. Through the process described above, the image data is converted into information having a pixel as the minimum unit. Here, a pixel is the minimum unit of the image formed by the line heads 29. The series of signal processing is executed on the image corresponding to one page for every input of the vertical request signal VREQ-Y, and the video data VD-Y, VD-M, VD-C, and VD-K corresponding to one line thus generated are sequentially output to the main-side communication module 52.

The main-side communication module 52 time-division multiplexes the four colors of video data VD-Y, VD-M, VD-C, and VD-K output from the image processing section 51, and transmits the multiplexed video data VD to the head controller HC serially via differential output terminals TX+, TX−. The vertical request signals VREQ_Y, VREQ_M, VREQ_C, and VREQ_K, and the horizontal request signals HREQ_Y, HREQ_M, HREQ_C, and HREQ_K are time-division multiplexed and input from the head controller HC via differential input terminals RX+, RX−. The request signals VREQ, HREQ are developed into parallel signals, and the vertical request signals VREQ (e.g., VREQ-Y) are input to the image processing blocks 512 (e.g., 512Y) for the respective colors.

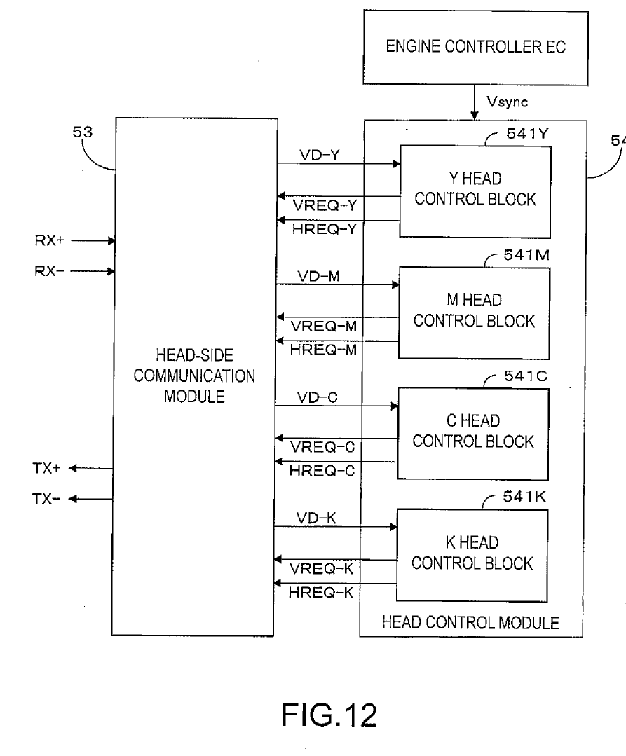

FIG. 12 is a block diagram showing the configuration of the head controller. The head controller HC includes a head-side communication module 53 and a head control module 54. The head-side communication module 53 time-division multiplexes the four colors of request signals output from the head control module 54, namely, the vertical request signals VREQ_Y, VREQ_M, VREQ_C, and VREQ_K, and the horizontal request signals HREQ_Y, HREQ_M, HREQ_C, and HREQ_K. The time-division multiplexed request signals are transmitted serially to the main controller MC via differential output terminals TX+, TX−. Meanwhile, the video data VD-Y, VD-M, VD-C, and VD-K are time-division multiplexed and input from the main controller MC via differential input terminals RX+, RX−. The video data VD-Y, VD-M, VD-C, and VD-K are developed into parallel signals and input to head control blocks 541Y, 541M, 541C, and 541K of the respective colors.

The head control module 54 has four head control blocks 541Y (yellow), 541M (magenta), 541C (cyan), and 541K (black) corresponding to the respective colors. The head control blocks 541Y, 541M, 541C, and 541K output the request signals VREQ_Y, VREQ_M, VREQ_C, VREQ_K, HREQ_Y, HREQ_M, HREQ_C, and HREQ_K for requesting the video data VD-Y, VD-M, VD-C, and VD-K, respectively, and meanwhile, control the exposure operations of the line heads 29 of the respective colors based on the video data VD-Y, VD-M, VD-C, and VP-K, thus received.

FIG. 13 is a block diagram showing a configuration of the head control block in the present embodiment. Although only the Y head control block 541Y for yellow is explained and discussed, the other blocks 541M, 541C, and 541K have the same structures. The Y head control block 541Y includes a request signal generation section 542 for generating the request signals VREQ-Y and HREQ-Y based on the sync signal Vsync provided from the engine controller EC. Upon reception of the sync signal Vsync, the request signal generation section 542 starts a counting operation of an internal timer, and outputs the vertical request signal VREQ-Y representing the top of the page when predetermined standby time has elapsed. Subsequent to the output of the vertical request signal VREQ-Y, the request signal generation section 542 outputs the corresponding number of pulses of the horizontal request signal HREQ-Y to the number of lines composing the image of one page repeatedly at a constant period. Request signals VREQ-Y and HREQ-Y are transmitted to the head-side communication module 53, and time-division multiplexed together with the request signals of the other colors to be transmitted to the main controller MC.

The horizontal request signal HREQ-Y is also input to a divisional HREQ signal generation section 543, and the divisional HREQ signal generation section 543 multiplies the request signal HREQ-Y by, for example, 16 to generate the divisional HREQ-Y signal. The divisional HREQ signal is input to an emission order control section 544, and the emission order control section 544 reorders the video data VD-Y based on the divisional HREQ signal. The reordering of the data is executed for reordering the video data VD-Y received line-by-line from the top of the page along the order with which the video data is transmitted to the drive circuits DC_A, DC_B, and DC_C.

As described later, each of the light emitting element group rows 295R forms the spot groups SG at the positions a sub-scanning spot group pitch Psgs shifted from each other in the sub-scanning direction SD (FIGS. 14-16). Therefore, in order to form the spot latent images corresponding to one line aligned in the main-scanning direction MD, it is necessary to transmit the video data VD-Y to the drive circuits DC_A, DC_B, and DC_C taking such a difference in the forming positions of the spot groups SG into consideration. Specifically, assuming that the value obtained by dividing the sub-scanning spot group pitch Psgs by a sub-scanning pixel pitch Rsd is “delayed line count”, the video data VD-Y is reordered so that the video data VD-Y the delayed line count shifted from each other in the sub-scanning direction SD is transmitted at the same transmission timing with respect to each of the light emitting element group rows 295R_A, 295R_B, and 295R_C. For example, at the timing when the video data VD-Y of the first line is transmitted to the light emitting element group row 295R_A, the video data VD-Y of the 161st line (=1 line+delayed line count) is transmitted to the light emitting element group row 295R_B, and the video data VD-Y of the 321st line (=1 line÷2×(delayed line count)) is transmitted to the light emitting element group row 295R_C.

An output buffer 545 supplies the drive circuits DC_A, DC_B, and DC_C with the reordered video data VD-Y via data transfer lines. The output buffer 545 is formed of, for example, shift registers, and the data transfer lines communicated from the output buffer 545 to each of the drive circuits DC_A, DC_B, and DC_C are used in common by the drive circuits. The drive circuits DC_A, DC_B, and DC_C drive the light emitting elements 2951 to emit light based on the video data VD-Y supplied from the output buffer 545. The drive emission by the drive circuits DC_A, DC_B, and DC_C is performed in sync with the emission switching timing Tu supplied from an emission timing generation section 546.

The divisional HREQ signal is also input to the emission timing generation section 546, and the emission timing generation section 546 generates the emission switching timing Tu based on the divisional HREQ signal. The emission timing generation section 546 is connected to each of the drive circuits DC_A, DC_B, and DC_C via an emission timing control line LTu, and the emission timing control line LTu is used in common by the drive circuits. The emission timing generation section 546 supplies each of the drive circuits DC_A, DC_B, and DC_C with the emission switching timing Tu via the emission timing control line LTu. The drive circuits DC_A, DC_B, and DC_C drive the light emitting elements 2951 of the light emitting element group rows 295R_A, 295R_B, and 295R_C to emit light based on the video data VD-Y supplied previously at the emission switching timing Tu. By thus controlling the drive and emission of the light emitting elements 2951 at the emission switching timing Tu, it is possible to form the spots SP respectively to the pixels PX on the surface of the photoconductor drum. The spot forming operation is hereinafter explained.

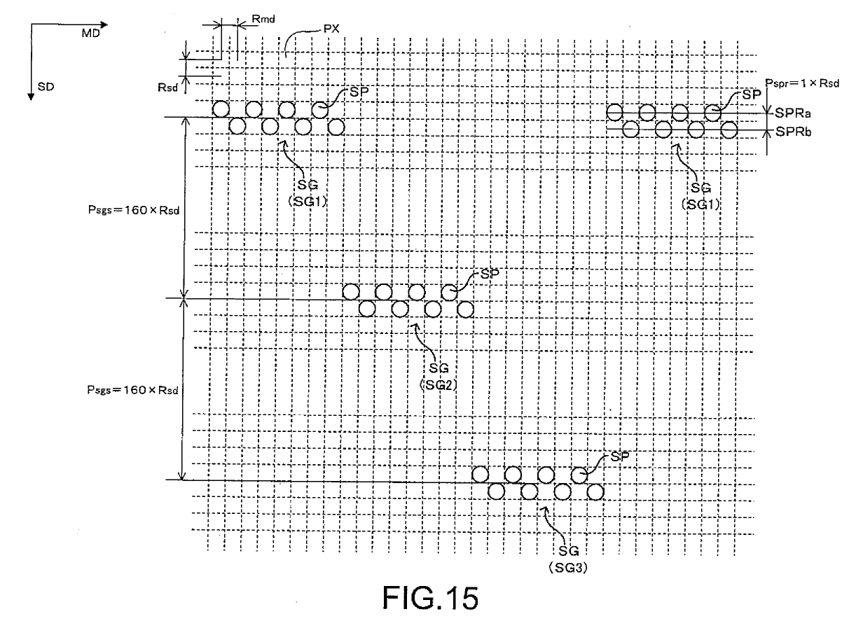

FIG. 14 is a perspective view for explaining the spot formation operation, and FIG. 15 is a diagram showing the spot groups formed on the surface of the photoconductor drum at the emission switching timing Tu in the present embodiment. The illustration of the lens array 299 is omitted in FIG. 14. The relationship between the spot group SG and the pixels PX is first explained, and the formation of the spots at the emission switching timing Tu is then explained.

As shown in FIG. 14, the light emitting element groups 295 can form the spot groups SG in different exposure regions ER in the main-scanning direction MD. The spot group SG is an aggregate of a plurality of spots SP formed when all of the light emitting elements 2951 in the light emitting element group 295 emit light simultaneously. The spot latent image is formed in the range exposed by the spot SP formed as described above. In the present embodiment, the two light emitting element groups 295 (e.g., the light emitting element groups 295_1, 295_2, or the light emitting element groups 295_2, 295_3) forming the spot latent images in adjacent exposure areas ER in the main-scanning direction MD are shifted from each other in the width direction LTD. Specifically, three light emitting element groups 295 capable of forming the spot groups SG in exposure regions ER arranged consecutively in the main-scanning direction MD are shifted from each other in the width direction LTD. The three light emitting element groups 295_1, 295_2, 295_3 capable of forming the spot groups SG_1, SG_2, SG_3 at the exposure regions ER_1, ER_2, ER_3 arranged consecutively in the main-scanning direction MD, for example, are shifted from each other in the width direction LTD. These three light emitting element groups 295 form the light emitting element group column 295C, and a plurality of light emitting element group columns 295C is arranged along the longitudinal direction LGD.

As illustrated with broken lines in FIG. 15, the surface of the photoconductor drum 21 is imaginarily provided with a plurality of pixels PX. A plurality of pixels PX arranged in the main-scanning direction MD forms a pixel line, and a plurality of pixel lines is arranged side by side in the sub-scanning direction SD. A pitch between adjacent pixels in the main-scanning direction MD is defined as a main-scanning pixel pitch Rmd, and a pitch between adjacent pixels in the sub-scanning direction SD is defined as a sub-scanning pixel pitch Rsd. In FIG. 15, both the main-scanning resolution and the sub-scanning resolution are 600 dpi (dots per inch), and therefore, the main-scanning pitch Rmd and the sub-scanning pitch Rsd, are equal to each other. Here, the resolution is the pixel density, and represents the number of pixels per inch.

The pixel pitch on the surface of the photoconductor drum can be obtained from, for example, the pixel pitch of an image formed on a paper sheet. There are some cases in which the moving speed of the surface of the photoconductor drum and the conveying speed of the paper sheet are slightly different from each other in the sub-scanning direction SD, and in such cases, the sub-scanning pixel pitch is different between the surface of the photoconductor drum and the paper sheet. Therefore, in the case in which the sub-scanning pixel pitch on the surface of the photoconductor drum is obtained from the image formed on the paper sheet, it is possible to multiply the sub-scanning image pitch obtained from the image on the paper sheet by the speed ratio of the moving speed of the surface of the photoconductor drum to the conveying speed of the paper sheet. A value described in the specification of the image forming device such as a printer can be used as the speed ratio.

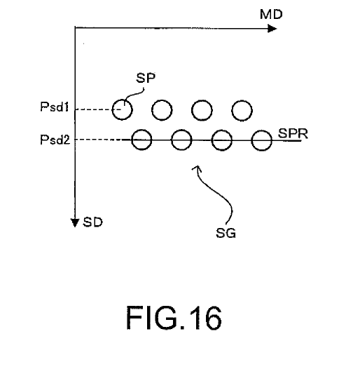

As shown in FIGS. 14 and 15, two spot rows SPRa, SPRb are arranged in the sub-scanning direction SD at the spot row pitch Pspr in each of the spot groups SG. In FIG. 15, symbols SPRa, SPRb are provided to the spot rows, and in the spot rows provided with the same symbol, the positions (in-group sub-scanning positions) of the spots in the spot groups SG in the sub-scanning direction SD are the same as each other. Here, “in-group sub-scanning position” denotes a position of an object (e.g., the spot or the spot row) in the sub-scanning direction SD on the MD-SD coordination system provided to every spot group SG. In FIG. 16, for example, the in-group sub-scanning position of the spot SP is a position Psd1, and the in-group sub-scanning position of the spot row SPR is a position Psd2. FIG. 16 is an explanatory diagram of the in-group sub-scanning positions.

In the present embodiment, the spot row pitch Pspr is a value obtained by multiplying the sub-scanning pixel pitch Rsd by an integral number (i.e., 1) (FIG. 15). The spot groups SG formed by different light emitting element group rows 295R are located at different positions in the sub-scanning direction SD, and the pitch (the sub-scanning spot group pitch Psgs) in the sub-scanning direction SD between the spot groups SG is a value obtained by multiplying the sub-scanning pixel pitch Rsd by an integral number (160). The line head 29 is configured so that the pitch Pegr between the light emitting element groups in the width direction LTD and the pitch Plsr between the lenses LS in the width direction LTD are equal to each other, and are equal to the value obtained by multiplying the sub-scanning pixel pitch by an integral number (i.e., 160). Therefore, by thus configuring the line head 29, the sub-scanning spot group pitch Psgs can be easily and simply set to be a value obtained by multiplying the sub-scanning pixel pitch Rsd by an integral number.

As described above, in the line head of the present embodiment, the sub-scanning spot group pitch Psgs is a value obtained by multiplying the sub-scanning pixel pitch Rsd by an integral number. Further, in each of the spot groups SG, the pitch between the spots SP formed at the positions different from each other in the sub-scanning direction is a value obtained by multiplying the sub-scanning pixel pitch Rsd by an integral number (i.e., 1). In other words, the pitch Pspr in the sub-scanning direction SD between the spot rows SPRa, SPRb arranged in the sub-scanning direction SD is a value obtained by multiplying the sub-scanning pixel pitch Rsd by an integral number (i.e., 1).

Therefore, in the present embodiment, it is possible to form all of the spots SP on the respective pixels PX simultaneously at the emission switching timing Tu. Therefore, since the spots SP can appropriately be formed on the respective pixels PX only by controlling all of the light emitting elements 2951 at the same emission switching timing Tu, the emission switching timing control is simplified. Further, since all of the light emitting elements 2951 can be controlled at the same emission switching timing Tu, it is possible to use one emission timing control line LTu commonly in all of the light emitting element group rows 295R_A, 295R_B, and 295R_C, thus the configuration of the line head 29 is simplified (FIG. 13).

Further, in the present embodiment, each of the light emitting elements 2951 of the light emitting element groups emits light at the light emission timing Tu while the surface of the photoconductor drum 21 is moving in the sub-scanning direction SD, thereby forming the plurality of spot latent images Lsp aligned in the main-scanning direction MD.

FIG. 17 is a diagram showing an example of the spot latent image forming operation. As shown in the “FIRST EMISSION SWITCHING TIMING Tu” column in FIG. 17, when each of the light emitting elements 2951_1, 2951_3, 2951_5, and 2951_7 (first light emitting elements) of the light emitting element row 2951Ra (FIG. 10) is driven to emit light at the emission switching timing Tu to form each of the spots SP of the spot row SPRa, the spot latent images Lsp1, Lsp3, Lsp5, and Lsp7 (first latent images) are formed corresponding respectively to the pixels PX. Subsequently, after the surface of the photoconductor drum 21 is moved a distance corresponding to a value obtained by multiplying the sub-scanning pixel pitch Rsd (distance) by one, each of the light emitting elements 2951_2, 2951_4, 2951_6, and 2951_8 (second light emitting elements) of the light emitting element row 2951Rb is driven to emit light at the second emission switching timing Tu. Thus, each of the spots SP of the spot row SPRb is formed, and the spot latent images Lsp2, Lsp4, Lsp6, and Lsp8 (second latent images) are formed corresponding respectively to the pixels PX. As described above, each of the light emitting elements 2951 emits light in accordance with the movement of the surface of the photoconductor drum, thereby making it possible to form the plurality of spot latent images Lsp aligned in the main-scanning direction MD. As described above, in the present embodiment, spot latent images (adjacent spot latent images) adjacent to each other in the main-scanning direction MD are formed by the two light emitting elements 2951 belonging to different light emitting element rows 2951R. In other words, out of the two light emitting elements 2951_1 and 2951_2 for respectively forming the adjacent spot latent images Lsp1 and Lsp2, for example, the light emitting element 2951_1 belongs to the light emitting element row 2951Ra, while the light emitting element 2951_2 belongs to the light emitting element row 2951Rb.

As described above, in the present embodiment, the plurality of light emitting elements 2951 is grouped and disposed as the light emitting element group 295. Moreover, the two light emitting element groups 295 for forming spot latent images in exposure areas ER adjacent to each other in the main-scanning direction MD are shifted from each other in the width direction LTD. As a result, as shown in FIG. 9, since the light emitting groups 295 are disposed discretely in the longitudinal direction LGD, it is possible to dispose the light emitting element groups in a relatively large space. Therefore, it is possible to increase the size of each of the light emitting element 2951 forming the light emitting element group 295 with relative ease, thus making it possible to form the spot latent image with a sufficient amount of light.

Further, in the embodiment described above, the wirings WL connected respectively to the light emitting elements 2951 belonging to the same light emitting element group 295 are extended out to the same side (the “one side” in the embodiment described above) of the light emitting element group in the width direction LTD (FIG. 10). Therefore, in the present embodiment, it is possible to extend the wirings WL to the same light emitting element group 295 in a lump on the head substrate 293, thus making it possible to simplify the wiring pattern.

Further, by extending out each of the wirings WL to the same side of the light emitting element group, it is possible to easily make the wiring distances to the light emitting elements 2951 substantially equal to each other. Therefore, the line head 29 advantageously suppresses variation in the emission characteristics of the light emitting elements 2951, thereby forming preferable spot latent images.

Further, in the embodiment described above, the wirings WL are connected to the respective light emitting elements 2951 belonging to the same light emitting element group 295 from the side to which the wirings are extended out. According to this connection form of the wiring WL, the wiring distances are shortened compared to a case in which the wirings are connected to the respective light emitting elements 2951 from, for example, an opposite side (the “the other side” in FIG. 10) to the extended-out side of the wirings WL. As a result, the wiring WL is simplified.

Further, in the embodiment described above, the wirings WL extended out from the light emitting element group 295 are arranged in the longitudinal direction LGD in the order in which the light emitting elements 2951 as the connection destinations of the wirings are disposed in the light emitting element group 295 in the longitudinal direction LGD, thus emission control of the light emitting elements 2951 is simplified. Specifically, each of the drive circuits DC_A, DC_B, and DC_C provides the light emitting elements 2951 with the drive signals via the wirings WL. In order to appropriately form the spot latent images, the light emitting elements 2951 corresponding to the pixels to be provided with the spot latent images must be correctly provided with the drive signals. However, if the arrangement of the wirings WL is out of order independently of the order in which the light emitting elements 2951 are disposed, there is a possibility that the control of reordering the video data VD in accordance with such a wiring form is required. In contrast, in the present embodiment, the wirings WL are arranged in the longitudinal direction LGD in the order in which the light emitting elements 2951 are disposed. Therefore, control such as reordering of the video data VD as described above can be eliminated, thereby simplifying emission control of the light emitting elements 2951.

Further, in the embodiment described above, the light emitting element rows 2951R are shifted from each other in the longitudinal direction LGD so that the two light emitting elements 2951 for forming the spot latent images adjacent to each other in the main-scanning direction MD belong to different light emitting element rows 2951R. In other words, the two light emitting element 2951 forming the spot latent images adjacent to each other in the main-scanning direction are shifted from each other in the width direction LTD. Therefore, a relatively large inter-element space BE defined between the light emitting elements arranged in the longitudinal direction LGD in the light emitting element row 2951R (FIG. 10) is provided. Therefore, since the light emitting element 2951 can be formed in a relatively large space, the size of the light emitting element 2951 can be increased. As a result, the spot latent image can be formed with a sufficient amount of light even in high resolution, thus preferable spot latent image formation is possible.

Further, in the embodiment described above, organic EL elements are used as the light emitting elements 2951. Organic EL elements emit light with intensity lower than that of, for example, light emitting diodes (LED) and so on. Therefore, the present embodiment of the invention capable of increasing the size of the light emitting element 2951 is particularly preferably applied to configurations with organic EL elements. In particular, since the bottom emission organic EL elements as in the present embodiment described above emit light with lower intensity, the invention is preferably applied to configurations using the bottom emission organic EL elements as the light emitting elements 2951.

As described above, in the present invention, the main-scanning direction MD and the longitudinal direction LGD correspond to “a first direction”, the sub-scanning direction SD and the width direction LTD correspond to “a second direction”, the photoconductor drum 21 corresponds to “a latent image carrier”, the surface of the photoconductor drum 21 corresponds to “an image plane”, and the head substrate 293 corresponds to “a substrate”. Further, the line head 29 corresponds to “an exposure head”, the lens LS corresponds to “an imaging optical system”, and the spot SP corresponds to “a light-collected section”.

### Other Issues

The invention is not limited to the embodiment described above, and can be modified and remain within the scope of the invention. For example, in the embodiment described above, the light emitting element group 295 is composed of two light emitting element rows 2951R arranged side by side in the width direction LTD. However, the number of light emitting element rows 2951R is not limited to two, and can be changed according to needs. Further, the number of light emitting elements 2951 forming each of the light emitting element rows 2951R can also be changed if necessary. For example, the following modification is possible.

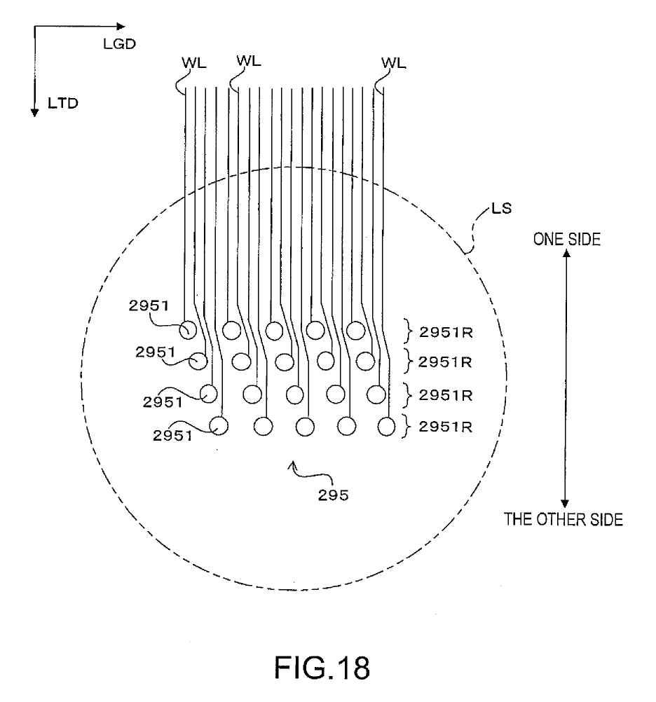

FIG. 18 is a plan view showing another configuration of the light emitting element group. In FIG. 18, in order to show the relationship between the light emitting element group 295 and the lens LS, the lens LS is illustrated with the double-dashed line. In the light emitting element group 295, four light emitting element rows 2951R each having five light emitting elements 2951 aligned in the longitudinal direction LGD are arranged side by side in the width direction LTD. The light emitting element rows 2951R are shifted from each other in the width direction LTD, and the light emitting elements 2951 are located at different positions in the width direction LTD. Each of the light emitting element rows 2951R emits light at a timing corresponding to movement of the surface of the photoconductor drum 21, and thus a plurality of spot latent images aligned in the main-scanning direction MD can be formed.

All of the wirings WL connected to the light emitting elements 2951 in the light emitting element group 295 are extended out to the one side of the light emitting element group 295 in the width direction LTD. In particular, in FIG. 18, each of the wirings WL is extended out of the lens LS. The wirings WL are connected to the light emitting elements 2951 from the extended-out side (the one side) of the wirings WL. The wirings WL extended out from the light emitting element group 295 are arranged in the longitudinal direction LGD in the same order as the order in the longitudinal direction LGD of the light emitting elements 2951 of the light emitting element group 295 as the connection destination of the wirings WL.

In FIG. 18, the wirings WL connected to the light emitting elements 2951 belonging to the same light emitting element group 295 are extended out to the same side (the “one side”) of the light emitting element group in the width direction LTD. Therefore, the wirings WL can be extended to the light emitting element group 295 in a lump on the head substrate 293, thus simplifying the wiring pattern. Further, the wirings WL are arranged in the order in which the light emitting elements 2951 are disposed, thereby simplifying emission control of the light emitting elements 2951.

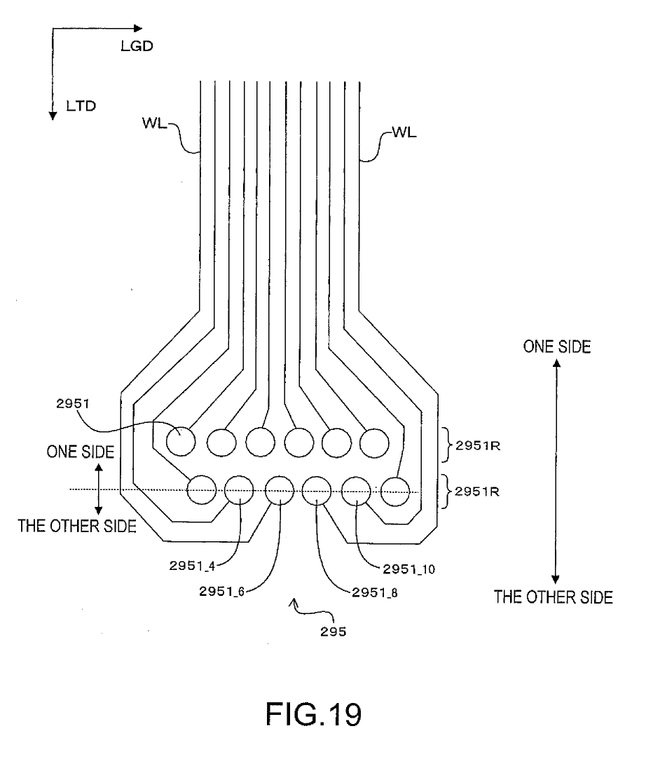

Further, although the wirings WL are connected to the light emitting elements 2951 from the extended-out side (the “one side”) of the wirings WL, the wirings WL can be connected to the light emitting elements 2951 in the following manner. FIG. 19 is a plan view showing still another configuration of the light emitting element group. In the light emitting element group 295, two light emitting element rows 2951R each having six light emitting elements 2951 aligned in the longitudinal direction LGD are arranged side by side in the width direction LTD. The light emitting element rows 2951R are shifted from each other in the width direction LTD, and the light emitting elements 2951 are located at different positions in the width direction LTD. Each of the light emitting element rows 2951R emits light at a timing corresponding to movement of the surface of the photoconductor drum 21 and thus a plurality of spot latent images aligned in the main-scanning direction MD can be formed.

Further, all of the wirings WL connected respectively to the light emitting elements 2951 in the light emitting element group 295 are extended out to the one side of the light emitting element group 295 in the width direction LTD. This point is shared in common by the configuration of the light emitting element group shown in FIG. 19 and the other embodiments described above. However, the configuration shown in FIG. 19 and the embodiments described above are different in the way of connecting the wirings to the light emitting elements 2951. Specifically, in FIG. 19, the wirings WL corresponding to the light emitting elements 2951_4, 2951_6, 2951_8, and 2951_10 are connected to the respective light emitting elements from the opposite side (“the other side”) to the extended-out side of the wirings WL.

Also in FIG. 19, the wirings WL connected respectively to the light emitting elements 2951 belonging to the same light emitting element group 295 are extended out to the same side (the “one side” in the embodiment described above) of the light emitting element group in the width direction LTD. Therefore, the wirings WL can be extended to the light emitting element group 295 in a lump on the head substrate 293, thus simplifying the wiring pattern. Further, because the configuration of FIG. 19 eliminates passage of the wirings WL pass between the light emitting elements 2951 in one of the light emitting element rows of the light emitting element group 295 as is the case with the configuration shown in FIG. 10, the size of the light emitting element 2951 can further be increased.

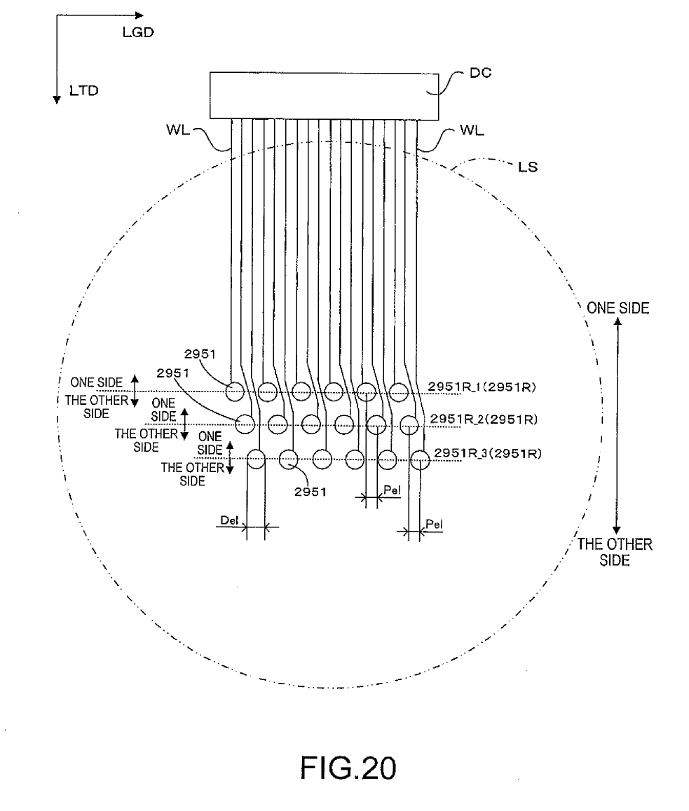

FIGS. 20-22 are plan views showing further modified examples of the light emitting element group and the wirings connected to the light emitting element group. FIGS. 20-22 each show a configuration of the reverse side of the head substrate 293 viewed from the obverse side of the head substrate 293. In FIGS. 20-22, although the lens LS is illustrated with double-dashed line, this does not denote that the lens LS is disposed on the reverse surface of the head substrate 293, but denotes the positional relationship between the light emitting element group 295 and the lens LS in the plan view.

In the modified example of FIG. 20, six light emitting elements 2951 are aligned in the longitudinal direction LGD to form the light emitting element row 2951R. In the light emitting element group 295, three light emitting element rows 2951R are disposed at different positions in the width direction LTD. The light emitting element rows 2951R are shifted by the light emitting element pitch Pel from each other in the longitudinal direction LGD, and the positions of the light emitting elements 2951 are different in the longitudinal direction LGD. The diameter Del (the width in the longitudinal direction LGD) of each of the light emitting elements 2951 in the longitudinal direction is longer than the light emitting element pitch Pel. Further, the two light emitting elements 2951 (first and second light emitting elements) disposed with a light emitting element pitch Pel in the longitudinal direction LGD form spot latent images adjacent to each other in the main-scanning direction MD. In other words, the two light emitting elements 2951 forming the spots SP adjacent to each other in the main-scanning direction MD belong to different light emitting element rows 2951R, and are disposed at positions different from each other in the width direction LTD. Therefore, in this modified example, the size of the light emitting element 2951 can be increased, thus the spots SP can be formed with a sufficient amount of light, thereby facilitating preferable latent image formation.

Further, in this modified example, the drive circuit DC is disposed on one side of the light emitting element group 295 in the width direction LTD. The drive circuit DC is disposed for every light emitting element group 295, and can be formed of thin film transistors (TFT) or the like. The drive circuit DC and the light emitting elements 2951 of the light emitting element group 295 are electrically connected via the wirings WL (first and second wirings). The wiring form of wirings WL is as follows. The wirings WL are connected to the one side of the light emitting elements 2951 in the width direction LTD. Each of the wirings WL is extended out to the one side thereof in the width direction LTD. The wirings WL connected to the light emitting element row 2951R_2 and 2951R _3 are extended out while passing between light emitting elements 2951 of the light emitting element rows 2951R other than the connection destination thereof. Each of the wirings WL is extended out of the lens LS in the plan view. Each of the wirings WL thus extended out to the one side of the light emitting element group 295 in the width direction LTD is connected to the drive circuit DC. The drive circuit DC provides the light emitting elements 2951 with the signals via the respective wirings WL to drive the light emitting elements 2951.

Also in this modified example, the wirings WL connected respectively to the light emitting elements 2951 are extended out to the one side thereof in the width direction LTD. Therefore, the wirings WL can be preferably and easily extended in a lump.

In particular, in this modified example, the drive circuit DC (circuit) electrically connected to the wirings WL is disposed on the one side in the width direction LTD. Therefore, the wirings WL extended out from the light emitting elements 2951 to the one side in the width direction LTD can be connected to the drive circuit DC in a lump, thus the wirings WL can easily be extended. By disposing such a drive circuit DC for every light emitting element group 295, the drive circuit DC can be disposed near to each of the light emitting element groups 295, thus the wirings can be relatively short. As a result, a signal hardly blunted by stray capacitance of the wirings WL is supplied to the light emitting elements 2951, which is advantageous to preferable latent image formation operation.

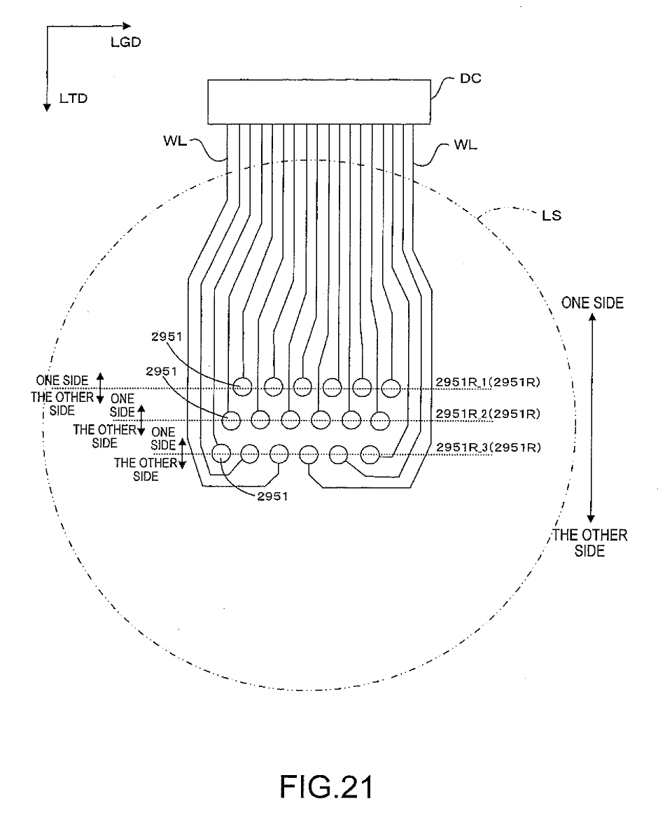

The modified example of FIG. 21 is now explained. The principal difference between the examples of FIGS. 21 and FIG. 20 is the form of disposing the wirings WL connected to the light emitting element row 2951R_3. Therefore, the description focuses on this difference, sections common to FIGS. 21 and 20 are denoted with the same reference numerals, and repeat explanations are omitted. As shown in FIG. 21, the wirings WL connected to the light emitting element row 2951R_3 are extended out to the one side of the light emitting element group 295 in the width direction LTD while circumventing the light emitting element rows 2951R_2 and 2951R_1 that are not the connection destination of the these wirings WL, and the wirings WL connected to these light emitting element rows. Thus, since the number of wirings WL passing between the light emitting elements 2951 of the light emitting element rows 2951R_1 and 2951R_2 can be reduced, this configuration is advantageous to increasing the size of the light emitting element 2951.

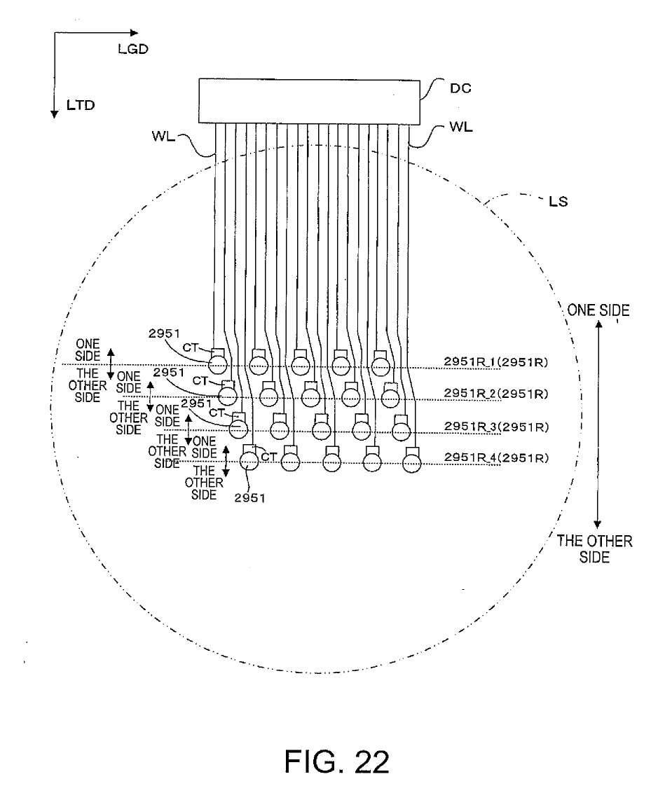

The modified example of FIG. 22 is now explained. The example of FIG. 22 is characterized in the contact CT provided to each of the light emitting elements 2951, and the other sections are common to the modified example shown in FIG. 18. Therefore, the description focuses on this difference. Sections common to the modified example of FIG. 18 are denoted with the same reference numerals, and repeat explanations are omitted.

The contact CT is for connecting the anode material of the organic EL element, such as Indium Tin Oxide (ITO), and the wirings WL to each other. By disposing the contact CT in the vicinity of the light emitting element 2951, freedom of the wirings WL can be achieved. Further, if the contact CT is disposed in the vicinity of the light emitting element 2951, the contact CT may affect application of the organic EL material in the manufacturing process of the light emitting element 2951. Therefore, unevenness in application of the organic EL material maybe caused. However, in the example of FIG. 22, the contacts CT are disposed on the one side of the respective light emitting elements 2951 in the width direction LTD. Therefore, the application condition of the organic EL material is easily controlled. As a result, unevenness in application of the organic EL element is suppressed and the light emitting elements 2951 are preferably formed.

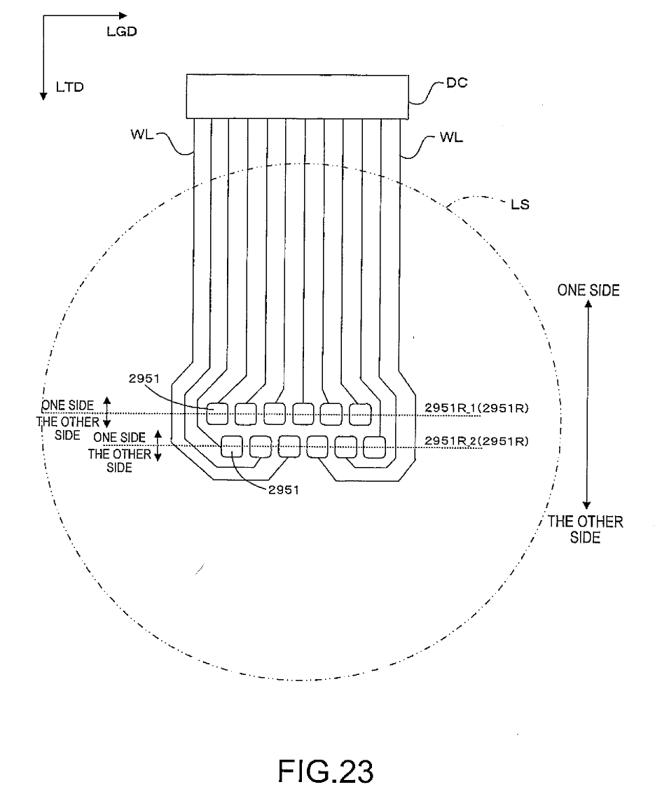

In the embodiments described above, the shape of the light emitting element 2951 is a circle. However, the shape of the light emitting element 2951 is not limited to a circle. FIG. 23 is a plan view showing a modified example of the shape of the light emitting element. As shown in FIG. 23, the shape of the light emitting element 2951 may be a rectangle. When comparing a case in which a plurality of rectangular light emitting elements 2951 is disposed at a certain pitch with a case in which a plurality of circular light emitting elements 2951 is disposed at the same pitch, a larger surface area can be obtained with the rectangular light emitting elements 2951 than with the circular light emitting elements 2951. Therefore, rectangular light emitting elements 2951 are advantageous to increasing the amount of light.

Further, in the embodiment described above, the wirings WL connected respectively to the light emitting elements 2951 belonging to the same light emitting element group 295 are extended out to the “one side” of the light emitting element group in the width direction LTD. However, wirings WL can also be extended out in the other side of the light emitting group in the width direction LTD. In other words, it is sufficient that the wirings WL connected to the respective light emitting elements 2951 belonging to the same light emitting element group 295 are extended out to the same side of the light emitting element group 295 in the width direction LTD.

Further, the side to which the wirings WL are extended out can differ between the light emitting element groups 295. In other words, the wirings WL connected to light emitting elements 2951 belonging to the light emitting element group 295_1 (FIG. 9) may all be extended out to the one side, while the wirings WL connected to light emitting elements 2951 belonging to the light emitting element group 295_2 (FIG. 9) may all be extended out to the other side. The side to which the wirings WL are extended out may be matched between all of the light emitting element groups 295.

Further, although the light emitting element group column 295C is formed of three light emitting element groups 295 in the embodiment described above, the number of light emitting element groups 295 composing the light emitting element group column 295C is not limited thereto.

Further, although in the embodiments described above, organic EL elements are used as the light emitting elements 2951, the light emitting material applicable to the light emitting elements 2951 is not limited thereto. Light emitting diodes (LED), for example, can also be used as the light emitting elements 2951.

Further, the wirings WL are connected to the drive circuit DC in FIGS. 20-23. However, the wirings WL may also be connected to flexible printed circuits (FPC) or the like to input the signals to the respective light emitting elements 2951 via the FPC.

Further, although in the embodiment described above, both the main-scanning and sub-scanning resolutions are 600 dpi, the resolutions are not limited to 600 dpi. Regarding the sub-scanning resolution, a resolution higher than 600 dpi can be realized with relative ease by breaking the emission time of the light emitting elements 2951 into small parts using pulse width modulation (PWM) control. Therefore, for example, the sub-scanning resolution can be increased to 2400 dpi while the main-scanning resolution is set to 600 dpi. In this example, since the sub-scanning resolution is four times the main-scanning resolution, the sub-scanning pixel pitch Rsd becomes one fourth of the main-scanning pixel pitch Rmd.

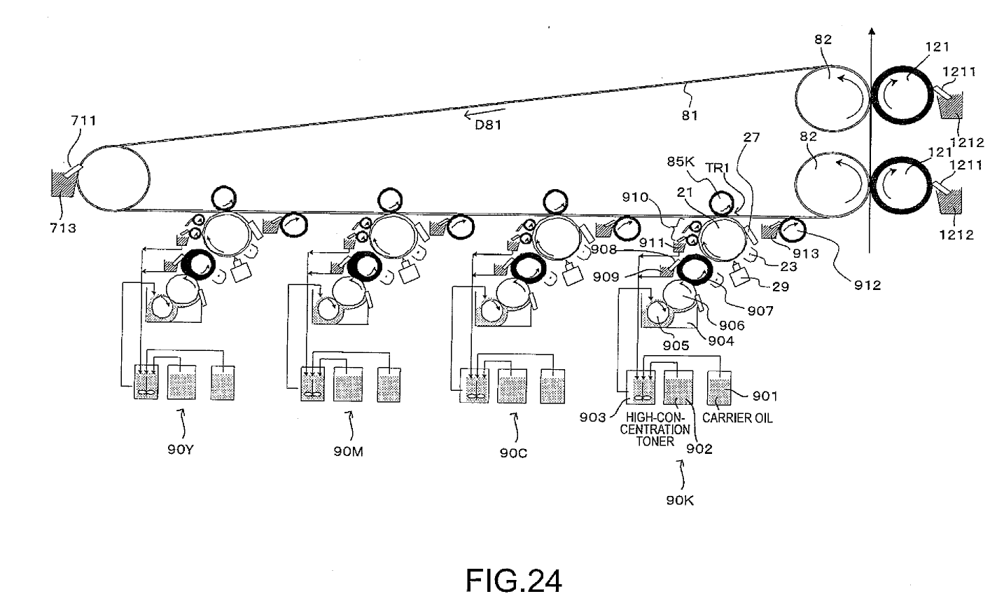

Further, although in the embodiments described above, image formation is executed by developing the latent image using so-called dry toners, it is possible to develop the latent image using liquid developers. FIG. 24 is a diagram schematically showing a device for performing development with a liquid developer. Since the devices of FIGS. 24 and 3 differ primarily in the configuration of the developing unit, the following description focuses on the developing unit. Other sections are denoted with corresponding reference numerals, and repeat explanations are omitted.

Four developing units 90Y (yellow), 90M (magenta), 90C (cyan), and 90K (black) corresponding to the respective toner colors are disposed side by side along the conveying direction of the intermediate transfer belt 81. Each of the developing units 90Y, 90M, 90C, and 90K includes an oil container 901 for containing a carrier oil, a toner container 902 for containing a high-concentration toner, and an agitator 903. The agitator 903 agitates carrier oil supplied from the oil container 901 and high-concentration toner supplied from the toner container 902 to generate a liquid developer with adjusted concentration. The liquid developer thus generated is supplied to the developer container 904. A supply roller 905 and an anilox roller 906 are disposed inside the developer container 904. The lower part of the supply roller 905 is dipped in the liquid developer inside the developer container 904. The supply roller 905 rotates in the direction indicated by the arrow in FIG. 24 to draw up the liquid developer to feed the liquid developer to the anilox roller 906. The anilox roller 906 rotates in the direction indicated by the arrow in the drawing to apply the liquid developer fed from the supply roller 905 to a developing roller 907.

The developing roller 907 contacts the photoconductor drum 21 at the developing position. The developing roller 907 is rotatable in the direction indicated by the arrow in FIG. 24, and the liquid developer supplied from the anilox roller 906 is held on the surface of the developing roller 907, and supplied to the developing position. The toner included in the liquid developer supplied as described above adheres to the latent image on the surface of the photoconductor drum, and development is thus executed.

A cleaner blade 908 contacts the developing roller 907 on the downstream side of the developing position in the rotational direction of the developing roller 907. The cleaner blade 908 strips off liquid developer from the surface of the developing roller 907, and a recovery container 909 recovers the liquid developer thus stripped off. Liquid developer recovered by the recovery container 909 is returned to the agitator 903 and reused.

Two photoconductor squeezing rollers 910 that contact the surface of the photoconductor drum 21 are disposed on the downstream side of the developing position in the rotational direction D21 of the photoconductor drum. The photoconductor squeezing rollers 910 strip off carrier oil from the surface of the photoconductor drum 21. Thus, the amount of carrier oil included in the liquid developer on the surface of the photoconductor drum 21 is adjusted. Carrier oil thus stripped off is once recovered by the recovery container 911, and then returned to the agitator 903 to be reused.

The image obtained by developing the latent image at the developing position is transferred to the intermediate transfer belt 81 at a primary transfer position TR1. A belt squeezing roller 912 contacts the intermediate transfer belt 81 on the downstream side of the primary transfer position TR1 in the conveying direction D81 of the intermediate transfer belt 81. The belt squeezing rollers 912 strip off carrier oil from the surface of the intermediate transfer belt 81. Thus, the amount of carrier oil included in the liquid developer on the surface of the intermediate transfer belt 81 is adjusted. The stripped off carrier oil is recovered by a recovery container 913.

The primary-transferred image is secondary-transferred to a paper sheet. The secondary transfer operation is executed by two secondary transfer rollers 82 and the backup rollers 121 opposed respectively to the two secondary transfer rollers 82. A cleaner blade 1211 contacts each of the backup rollers 121 to strip off the liquid developer remaining on each of the backup rollers 121, and liquid developer stripped off by the cleaner blade 1211 is recovered by recovery containers 1212.

As described above, in the device of FIG. 24, the latent image is liquid-developed using liquid developers. In general, liquid development of the latent image can be executed with relatively high resolution. Therefore, the development of the spot latent images is preferably formed by the embodiments of the invention using the liquid development process.

What is claimed is:

1. An exposure head comprising:
an imaging optical system arranged in a first direction;
a first light emitting element and a second light emitting element disposed in a second direction substantially perpendicular to the first direction, and that emit light beams to be imaged by the imaging optical system to form light-collected sections adjacent to each other in the first direction;
a first wiring electrically connected to and extended out from the first light emitting element to one side in the second direction; and
a second wiring electrically connected to and extended out from the second light emitting element to the one side in the second direction.

2. The exposure head according to claim 1, further comprising:
a circuit disposed on the one side in the second direction, and electrically connected to the first and second wirings.

3. The exposure head according to claim 2, wherein the circuit is a drive circuit that drives the first and second light emitting elements.

4. The exposure head according to claim 3, wherein the drive circuit is a thin film transistor.

5. The exposure head according to claim 2, wherein the circuit is a flexible printed circuit.

6. An image forming device comprising:
a latent image carrier;
an exposure head having
an imaging optical system arranged in a first direction,
a first light emitting element and a second light emitting element disposed in a second direction substantially perpendicular to the first direction, and that emit light beams to be imaged on the latent image carrier by the imaging optical system to form latent images adjacent to each other in the first direction on the latent image carrier,
a first wiring electrically connected to and extended out from the first light emitting element to one side in the second direction, and
a second wiring electrically connected to and extended out from the second light emitting element to the one side in the second direction; and
a development section that develops the latent images formed by the exposure head on the latent image carrier.

7. The image forming device according to claim 6, further comprising:
a circuit disposed on the one side in the second direction, and electrically connected to the first and second wirings.

8. The image forming device according to claim 6, wherein
the first and second light emitting elements emit light in accordance with movement of the latent image carrier to form the latent images adjacent to each other in the first direction.

9. The image forming device according to claim 8, further comprising:
at least one light emitting element disposed consecutively to the first light emitting element in the first direction to form a first light emitting element row; and
at least one light emitting element disposed consecutively to the second light emitting element in the first direction to form a second light emitting element row.

10. The image forming device according to claim 9, wherein
a width of the first light emitting element is longer than a distance in the first direction between the first and second light emitting elements.

11. The image forming device according to claim 9, wherein
a distance in the second direction between a first latent image formed by the first light emitting element and a second latent image formed by the second light emitting element when the first and second light emitting elements emit light simultaneously is an integral multiple of a distance in the second direction between pixels.

12. The image forming device according to claim 6, wherein the light emitting element is an organic EL element.

13. The image forming device according to claim 12, wherein the organic EL element is a bottom emission organic EL element.

14. The image forming device according to claim 6, wherein the latent image is developed using a liquid developer.
